(19) United States
(12) Patent Application Publication
(10) Pub. No.: US 2024/0267704 A1
(43) Pub. Date: Aug. 8, 2024

(54) NETWORK SITE DETERMINATION IN A TELECOMMUNICATIONS NETWORK

(71) Applicant: Level 3 Communications, LLC, Broomfield, CO (US)

(72) Inventors: William GRAY, Boulder, CO (US); Nathaniel NELSON, Boulder, CO (US); Mark PULLINS, Boulder, CO (US)

(73) Assignee: Level 3 Communications, LLC, Broomfield, CO (US)

(21) Appl. No.: 18/411,821

(22) Filed: Jan. 12, 2024

Related U.S. Application Data
(60) Provisional application No. 63/483,621, filed on Feb. 7, 2023.

(51) Int. Cl. H04W 4/021

(52) U.S. Cl. CPC H04W 4/021

(57) ABSTRACT

Aspects of the present disclosure describe a network site validation and remediation system and method that provides validation and remediation of serviceable site locations in a network. The network site validation and remediation system may determine possible inaccurate site location data and cause one or more mitigation actions to be performed based on the determination of the inaccurate location data. Accuracy of site location is determined based on a combination of rules, where an accuracy score is used to provide a measure of confidence that a site's location data (e.g., address and/or geocoordinates) accurately reflects the physical location where a network connection is provided and thus, where service exists or potentially can be deployed. The one or more mitigation actions may cause inaccurate site location data to be corrected with accurate location data determined by the system.

### CROSS-REFERENCE TO RELATED APPLICATIONS

This application claims the benefit of U.S. Provisional Application No. 63/483,621 filed Feb. 7, 2023, entitled “Network Site Determination in a Telecommunications Network, which is incorporated herein by reference in its entirety.

### BACKGROUND

Telecommunication networks provide, among other functions, Internet, voice, and many other services for customers that may have different possible service requirements. Such communications networks generally include one or more wire centers dispersed in the regions serviced by the network. A wire center connects to various sites, such as living units, business units, and the like, associated with customers. The wire center is connected to such sites with one or more communications nodes, such as cross connects. Each of the communications nodes may involve a different node type, such as copper-fed internet protocol (CoIP), fiber to the node (FTTN), fiber to the home/fiber to the premise (FTTH/FTTP), etc. The node type generally dictates the type of services that may be provided to a customer.

The various sites at which services are enabled may include location data (e.g., geographic coordinates and/or addresses), which may be stored in association with the various sites in one or more network site storage systems. Determining the services available from a communications network at a customer site or location often references the address of the customer. However, site addresses are often unreliable or do not accurately reflect a particular geographic location. As an example, many addresses are not assigned to a residential building until a person moves into the building and may take several months for address databases to be updated. A homeowner that moves into a newly built home may have to wait several months to receive an address. If the homeowner requests communication services at the home, a network manager or automated system may be unable to determine if such services are available to the home. As another example, large plots of land may be associated with a single address correlated to a position along a street. However, the availability of services across the entire plot of land may differ from that available at the address location. For these and other examples, associating site addresses with an available service of a communications network has potential for significant inaccuracies, leading to inefficient operation of the communications network.

It is with these observations in mind, among others, that aspects of the present disclosure were conceived.

### SUMMARY

The present disclosure describes a system and method for providing network service location validation and remediation. The network site validation and remediation system may determine possible inaccurate site location data and cause one or more mitigation actions to be performed based on the determination of the inaccurate location data. Accuracy of site location is determined based on a combination of rules, where an accuracy score is used to provide a measure of confidence that a site's location data (e.g., address and/or geocoordinates) accurately reflects the physical location where a network connection is provided and thus, where service exists or potentially can be deployed. The one or more mitigation actions may cause inaccurate site location data to be corrected with accurate location data determined by the system.

According to an aspect, a method is provided, comprising: retrieving, from one or more network site storage systems, existing location data of a plurality of sites, wherein each site comprises a potential service location for telecommunications services and the existing location data for each of the plurality of sites comprises at least existing geocoordinates and an existing address; determining external location data for the plurality of sites based on the existing location data, wherein determining external location data for the plurality of sites comprises, for each site, at least two of: determining occupancy data for the site; determining geocode data for the site; determining reverse-geolocation data for the site; determining one or more possible alternate addresses for the site; determining parcel data for the site; determining building data for the site; and determining business location data for the site; determining accuracy scores for the existing location data, each accuracy score indicating a level of confidence that the existing location data for a site is accurate, wherein determining the accuracy score for each site comprises at least two of: determining a parcel match score for the parcel data, where the parcel match score is a measure of a match between the existing address and a parcel address; determining a building match score for the building data, where the building match score is a measure of a match between the existing geocoordinates and building boundaries; determining a geocode match score for the geocode data, where the geocode match score is a measure of a match between the existing geocoordinates and geocode coordinates; determining a reverse-geocode match score for the reverse geocode data, where the reverse geocode match score is a measure of a match between the existing address and a reverse-geocode address; determining an occupancy match score for the occupancy data, where the occupancy match score is a measure of a match between a site unit count of a location aggregation including the site and an occupiable unit count; and determining a business match score for the business data, where the business match score is a measure of a number of businesses within a threshold distance of the site; based on determining an accuracy score indicating a set of the existing location data is accurate, validating the existing location data; and based on determining an accuracy score indicating a set of the existing location data is not accurate, automatically causing at least one mitigation action to be performed.

According to an aspect, a system is provided, comprising: at least one processor; and memory storing instructions that, when executed by the at least one processor, cause the system to: retrieve, from one or more network site storage systems, existing location data of a plurality of sites, wherein each site comprises a potential service location for telecommunications services and the existing location data for each of the plurality of sites comprises at least existing geocoordinates and an existing address; determine external location data for the plurality of sites based on the existing location data, wherein determining external location data for the plurality of sites comprises, for each site, at least two of: determine occupancy data for the site; determine geocode data for the site; determine reverse-geolocation data for the site; determine one or more possible alternate addresses for the site; determine parcel data for the site; determine building data for the site; and determine business location data for the site; determine accuracy scores for the existing location data, each accuracy score indicating a level of confidence that the existing location data for a site is accurate, wherein determining the accuracy score for each site comprises at least two of: determine a parcel match score for the parcel data, where the parcel match score is a measure of a match between the existing address and a parcel address; determine a building match score for the building data, where the building match score is a measure of a match between the existing geocoordinates and building boundaries; determine a geocode match score for the geocode data, where the geocode match score is a measure of a match between the existing geocoordinates and geocode coordinates; determine a reverse-geocode match score for the reverse geocode data, where the reverse geocode match score is a measure of a match between the existing address and a reverse-geocode address; determine an occupancy match score for the occupancy data, where the occupancy match score is a measure of a match between a site unit count of a location aggregation including the site and an occupiable unit count; and determine a business match score for the business data, where the business match score is a measure of a number of businesses within a threshold distance of the site; based on determining an accuracy score indicating a set of the existing location data is accurate, validate the existing location data; and based on determining an accuracy score indicating a set of the existing location data is not accurate, automatically cause at least one mitigation action to be performed.

According to an aspect, a computer-readable storage medium is providing storing instructions that, when executed by a computer, cause the computer to: retrieve, from one or more network site storage systems, existing location data of a plurality of sites, wherein each site comprises a potential service location for telecommunications services and the existing location data for each of the plurality of sites comprises at least existing geocoordinates and an existing address; determine external location data for the plurality of sites based on the existing location data, wherein determining external location data for the plurality of sites comprises, for each site, at least two of: determine occupancy data for the site; determine geocode data for the site; determine reverse-geolocation data for the site; determine one or more possible alternate addresses for the site; determine parcel data for the site; determining building data for the site; and determine business location data for the site; determine accuracy scores for the existing location data, each accuracy score indicating a level of confidence that the existing location data for a site is accurate, wherein determining the accuracy score for each site comprises at least two of: determine a parcel match score for the parcel data, where the parcel match score is a measure of a match between the existing address and a parcel address; determine a building match score for the building data, where the building match score is a measure of a match between the existing geocoordinates and building boundaries; determine a geocode match score for the geocode data, where the geocode match score is a measure of a match between the existing geocoordinates and geocode coordinates; determine a reverse-geocode match score for the reverse geocode data, where the reverse geocode match score is a measure of a match between the existing address and a reverse-geocode address; determine an occupancy match score for the occupancy data, where the occupancy match score is a measure of a match between a site unit count of a location aggregation including the site and an occupiable unit count; and determine a business match score for the business data, where the business match score is a measure of a number of businesses within a threshold distance of the site; based on determining an accuracy score indicating a set of the existing location data is accurate, validate the existing location data; and based on determining an accuracy score indicating a set of the existing location data is not accurate, automatically cause at least one mitigation action to be performed.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIG. 1 is a block diagram showing an example network environment with one or more communication nodes which may be used in implementing embodiments of the present disclosure.

FIG. 2 is a block diagram illustrating a second example network operating environment for implementing embodiments of the present disclosure.

FIG. 3 is a block diagram illustrating example components of a network site validation and remediation system which may be used in implementing embodiments of the present disclosure according to an example.

FIG. 4 is a flowchart illustrating operations of a method for providing serviceable network site location validation and remediation according to an example.

FIG. 5 is a flowchart illustrating operations of a method for determining accuracy of network site location data according to an example.

FIG. 6 is a block diagram illustrating example location-associated data that may be evaluated for determining accuracy of network site location data according to an example.

FIG. 7 is a block diagram illustrating example location-associated data that may be evaluated for determining accuracy of network site location data according to an example.

FIG. 8 is a block diagram illustrating example location-associated data that may be evaluated for determining accuracy of network site location data according to an example.

FIG. 9 is a block diagram illustrating example location-associated data that may be evaluated for determining accuracy of network site location data according to an example.

FIG. 10 is a block diagram illustrating example location-associated data that may be evaluated for determining accuracy of network site location data according to an example.

FIG. 11 is a block diagram illustrating example location-associated data that may be evaluated for determining accuracy of network site location data according to an example.

FIG. 12 is a block diagram illustrating example location-associated data that may be evaluated for determining accuracy of network site location data according to an example.

FIG. 13 is a block diagram illustrating example location-associated data that may be evaluated for determining accuracy of network site location data according to an example.

FIG. 14 is a block diagram illustrating example location-associated data that may be evaluated for determining accuracy of network site location data according to an example.

FIG. 15 is a block diagram illustrating example location-associated data that may be evaluated for determining accuracy of network site location data according to an example.

FIG. 16 is a block diagram illustrating example location-associated data that may be evaluated for determining accuracy of network site location data according to an example.

FIG. 17 is an illustration showing an example mitigation action in association with network site location data determined as inaccurate according to an example.

FIG. 18 is an illustration showing another example mitigation action in association with network site location data determined as inaccurate according to an example.

FIG. 19 is a block diagram of a computing device with which one or more aspects of the disclosure may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The present disclosure describes systems and methods to provide validation and remediation of serviceable network site locations. For example, serviceable sites of a communications network may be represented in association with geographic location data (e.g., addresses and/or geographic coordinates/geocoordinates) in one or more inventory systems. Having accurate information about the locations of service-enabled sites may be useful for efficiently operating the communications network. For instance, accurate site location data includes location data stored in association with sites in the communication network, where the location data accurately reflects physical locations where network connections are provided and thus, where service exists or potentially can be deployed. When site location data is correct, an accurate number of service-enabled units may be determined based on the stored site data. For instance, site data may be utilized by various systems for internal and external reporting, such as for reporting of material nonpublic information. As another example, accurate location data ensures a customer is able to order communications services and can receive the communications services through an uninterrupted purchase flow. As another example, accurate location data improves efficiency for install and repair activities (e.g., technicians are dispatched to correct geospatial locations).

Alternatively, when site location data is inaccurate, the communications network may operate inefficiently. As an example, when location data stored in association with sites in the communication network does not accurately reflect physical locations where network connections are provided and thus, where service exists or potentially can be deployed, a customer may not be able to order communications services and receive the communications services through an uninterrupted purchase flow. For instance, determining whether requested services are available to an address provided by a customer, potential customer, or site manager may entail a time-consuming and intensive study of the capabilities of corresponding nodes and/or equipment installed in a connected node. Thus, in some examples, a service-enabled site may not be recognized or approved for requested services, and installation of the service may not be initiated to the location. For example, many new addresses for newly built structures are not recognized for several months until after the structure becomes occupied. This may create a situation where services may be available at a site before the address becomes official. Further, large plots of land may be associated with a single address correlated to a position along a street. However, the availability of services across the entire plot of land may differ from that available at the address location. Similarly, addresses may be entered into various site inventory systems differently. For example, some inventory systems may spell out each part of an address (“West” for W., “Street” for St.), while others may use abbreviations for some parts of the address. In other examples, site location data may be incorrectly input into some inventory systems (e.g., a unit may be missed, an additional unit may be included, or something may be misspelled).

For these and other reasons, accuracy of location data for sites in a network is helpful for effective operation of the network. Thus, aspects of the present disclosure describe a network site validation and remediation system and method that may be implemented for providing validation and remediation of serviceable site locations in a network. The network site validation and remediation system may determine possible inaccurate site location data and cause one or more mitigation actions to be performed based on the determination of the inaccurate location data. The one or more mitigation actions may cause inaccurate site location data to be corrected with accurate location data determined by the automated system and/or confirmed by user interaction. One example mitigation action includes automatically determining alternate addresses and/or geocoordinates for sites with inaccurate location data. Another example mitigation action includes automatically removing site location data that may be determined to be inaccurate. Another mitigation action may include automatically correcting site location data with determined alternate addresses and/or geocoordinates. Another mitigation action may include automatically providing one or more determinations made by the system (e.g., inaccurate site location data, alternate location data, mitigation action recommendations) to a separate mitigation system for correcting inaccurate site location data. For example, the network site validation and remediation system and method may ensure customers/site managers are able to order and receive communications services through an uninterrupted purchase flow, where previously they may have not qualified for service due to the incorrect location data. Additionally, accurate site data allows for accurate internal and external reporting of service-enabled units in a communications network.

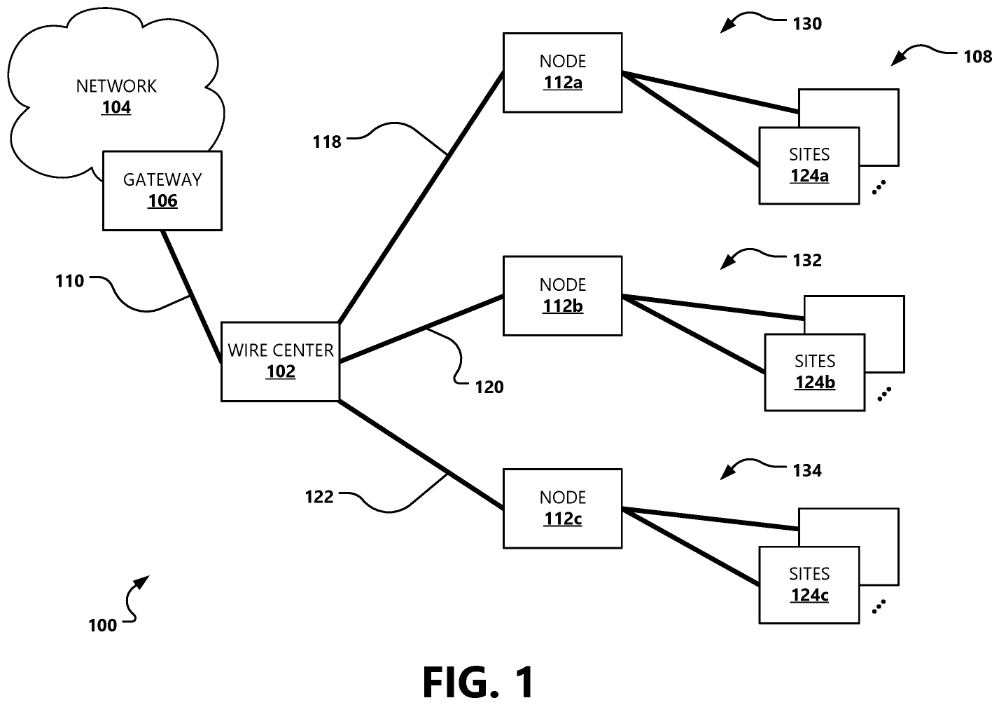

With reference now to FIG. 1, an example network environment 100 is described. In one implementation, the network environment 100 includes one or more wire centers 102. The wire centers 102 may be dispersed in geographical regions serviced by a network 104. Each of the wire centers 102 is part of a network 104 comprising numerous network components for communicating data across the network 104 and to provide telecommunication services, such as broadband or other Internet services, to end users 108, such as existing or potential customers. The network 104 may be managed by or otherwise associated with a telecommunications provider, such as a large Internet Service Provider (ISP), that facilitates communication and exchanges network traffic to provide the telecommunication services. For example, the network 104 may be a large network with a backbone stretching over a large geographical region, such as the United States. The network 104 may be in communication with various other networks that provide access to the network 104 to the end users 108 for receiving telecommunications services. In one implementation, the wire center(s) 102 are in communication with the network 104 via a gateway 106. The wire center(s) 102 may be connected to the gateway 106 with a high-bandwidth fiber 110.

Generally, each of the wire centers 102 includes central office switches providing connection to the network 104 and deploying network components enabling telecommunications services for the end user 108. In one implementation, one or more communications nodes, such as cross connects or other network connection devices, communicate data between the wire center 102 and one or more sites 124a, 124b, 124c (collectively, sites 124) associated with the end users 108 via one or more trunks, fibers, and/or other transmission channels between points. According to examples, a “site” 124 may be a location where a network connection is provided. Thus, a site 124 generally refers to that where service exists or potentially can be deployed. In other words, the sites 124 may include a potential service location. In some examples, each of the sites 124 may involve a connection with a physical building, such as a business or residence, associated with one or more of the end users 108. For example, the site 124 may be a living unit that is a single-family home or a living unit that is part of a multiple dwelling unit, such as an apartment complex. In some examples, a site 124 may be a business unit that is a single commercial unit or part of a multiple unit commercial complex. For simplicity, FIG. 1 depicts “sites” but, as noted, the sites 124 may be associated with a residence, commercial complex, and any other location where a network connection is provided.

One or more of the communications nodes 112a-112c (collectively, nodes 112) has a node type determined based on the type of networking equipment installed at the node. For example, the node type may be copper-fed internet protocol (CoIP), Fiber to the Node (FFTN), Fiber to the Premises (FTTP) (also referred to as Fiber to the House (FTTH)), and/or the like. In the illustrative, non-limiting example shown in FIG. 1, a first node 112a has a node type of CoIP, a second node 112b has a node type of FTTN, and a third node 112c has a node type of FTTP. In this example, the first node 112a is connected to the wire center 102 via a copper trunk 118 and connected to one or more sites 124a with a copper twisted pair 130 to provide Direct to Subscriber Line (DSL) services. The second node 112b is connected to the wire center 102 with fiber 120 and connected to one or more sites 124b with a copper twisted pair 132 to provide DSL services. Finally, the third node 112c is connected to the wire center 102 with fiber 122 and to one or more sites 124c with fiber 134 in a Gigabyte Passive Optical Network (GPON) architecture. Other node and network connectivity types are possible and are within the scope of the present disclosure.

There are benefits and drawbacks to each of these node types. The CoIP node type of the first node 112a and the FTTN node type of the second node 112b each involve the copper twisted pairs 130 and 132, with each channel of the copper twisted pairs 130 and 132 communicating in opposite directions between the nodes 112a/112b and each of the sites 124a/124b, respectively. In these cases, the node 112a/112b includes a box housing the connection to the wire center 102 and the pair of connections for each site. The FTTN node type of the second node 112b deploys the DSL equipment closer in physical proximity to the sites 124c than the CoIP node type of the first node 112a, reducing signal attenuation and increasing internet speed. To facilitate the closer proximity, however, a power pedestal and equipment cabinet are deployed at the third node 112b, increasing operational costs.

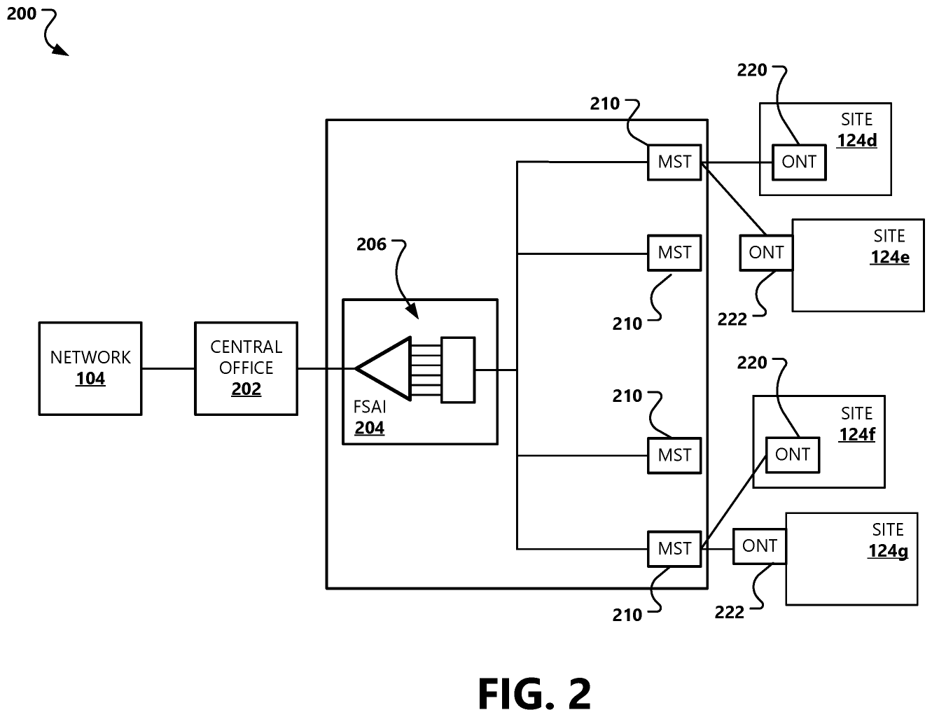

On the other hand, the FTTP node type of the third node 112c eliminates the need for the power pedestal and equipment cabinet. The GPON architecture involved with the third node 112c utilizes one fiber 122 providing two-way communication between the sites 124c and the wire center 102. FIG. 2 is a schematic diagram illustrating an Optical Distribution Network (ODN) operating environment in which embodiments of the present disclosure may be implemented. In the example implementation depicted in FIG. 2, the ODN network 200 may include a central office 202 to connect to the network 104. Generally, the bandwidth for the fiber 122 is high enough that it replaces the individual wires of other node types that are deployed to each site. The central office 202 may connect to a fiber serving area interface (FSAI) 204 that includes a passive optical splitter 206 for splitting the incoming optical signal into different wavelengths. A light distribution fiber may connect the FSAI 204 to one or more multiport service terminals (MSTs) 210. Although the MSTs 210 of FIG. 2 are illustrated as serving two sites (e.g., site 124d and 124g, each MST 210 may terminate a particular number of fibers of the light distribution fiber and typically may serve 8-12 termination sites or end users. Each end user or site 124d-124g may include an inside Optical Network Terminal (ONT) 220 or outside ONT 222 for communicating with a corresponding MST 210 and providing the communication services to the corresponding site. Through the ODN 200, fiber connections are provided to sites 124 from a network 104 to provide available services to those sites 124, such as high-speed internet or other communication services.

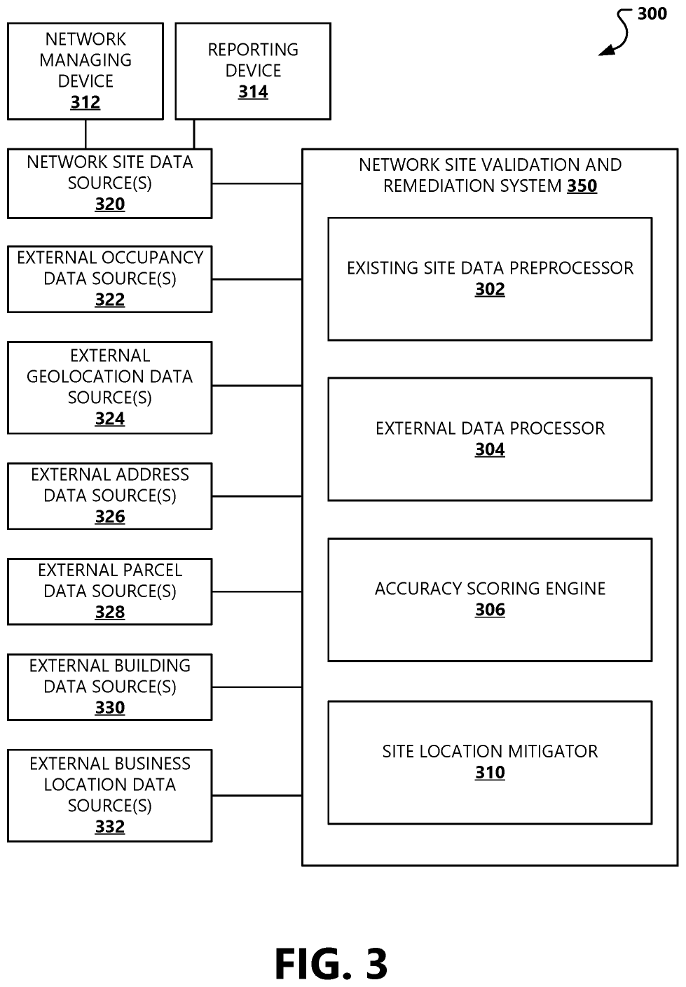

FIG. 3 is a schematic diagram of an example system 300 in which a network site validation and remediation system 350 may be implemented for providing validation and remediation of serviceable network site locations in accordance with an example. As discussed above, each node 112 may provide or potentially provide varying communication services to the sites 124 connected to those nodes. Thus, having accurate information about the sites 124 is helpful for efficiently operating the communications network 104. For instance, in some examples, location data for a site 124 may be accurate. That is, the location data stored in association with sites 124 in the communication network 104 may accurately reflect physical locations where network connections are provided and, thus, where service exists or potentially can be deployed. When site location data is accurate, various aspects of managing the communication network 104 operate efficiently. As one example, an accurate number of service-enabled units may be determined based on stored site data. As another example, accurate location data ensures a customer is able to order communications services can receive the communications services through an uninterrupted purchase flow. As another example, accurate location data improves efficiency for install activities (e.g., technicians are dispatched to correct geospatial locations).

In an example purchase flow for requesting and obtaining a particular service or services provided by the communication network 104 to the site 124, a customer or site manager may request a particular service or services provided by the network. In some examples, the customer or site manager may contact a network managing device 312 via a user interface provided by a computing device as part of requesting network services. Via the user interface, the customer/site manager may input the address associated with the site 124. In examples, the network managing device 312 may determine whether the received address is associated with a site 124 in one or more network site storage systems, which are herein referred to as one or more network site data source(s) 320. The network managing device 312 may provide the received address to one or more network site data sources 320 to obtain associated existing site data. When the address is matched to a site 124 stored in a network site data source 320, the network managing device 312 may provide the customer/network manager particular service options for the associated site 124. For instance, a correlation of the address to location data in the existing site data indicates that the correlated site 124 is a service-enabled unit. The network managing device 312 may further provide an approval for a requested network service, which may initiate installation of that service to the site 124. In another example, the network managing device 312 may provide a listing of all available services from which the customer/site manager may select to install at the site 124. In yet another example, the network managing device 312 may provide a listing of upcoming services and potential installation dates for when those services are available for the site 124. Further, the network managing device 312 may indicate that a particular service is not available for the site 124 and provide a reason for the unavailability of the service.

In other examples, the existing network site data may include inaccurate data, such as inaccurate location data (e.g., one or both of geocoordinates and address). When the network site data source 320 includes inaccurate site location data, the network managing device 312 may be unable to accurately determine if such services are available to the address input by the customer/site manager without a time-consuming and intensive study of the capabilities of the corresponding nodes 112 and/or equipment installed in a connected node. In some examples, the network managing device 312 may thus be unable to provide an approval for a requested network service, and installation of the service may not be initiated to the site 124. In some examples, network site data is utilized by various systems for internal and external reporting. For these and other reasons, accuracy of the network site data may be significant for operation of the network 104. Thus, the network site validation and remediation system 350 may be implemented for providing validation and remediation of serviceable network site locations.

In general, the network site validation and remediation system 350 may include an existing site data preprocessor 302, an external data processor 304, an accuracy scoring engine 306, and a site location mitigator 310. It should be appreciated that the system 300 may have different components, additional components, or fewer components than those described herein. For instance, two or more components of the network site validation and remediation system 350 may be combined into a single component. In some examples, the existing site data preprocessor 302 may obtain and preprocess existing network site data. In further examples, the external data processor 304 is in communication with one or more external data sources to acquire and match various data from one or more external data sources to existing network site data. For instance, existing network site data may include location data (e.g., existing geocoordinates and/or existing addresses) of a plurality of sites 124 in a communications network 104. The existing network site data may be stored in one or a combination of inventory systems, which are herein referred to as network site data sources 320. In some examples, the existing site data preprocessor 302 is configured to aggregate a set of existing network site data to a location level (e.g., a unique set of street address and geocoordinate values). In some examples, a unique location-level data aggregation (sometimes referred to generally as a “location”) may include one site 124, which may be associated with a site identifier (ID). For instance, a single-family home having a particular street address may be determined as one site 124 and may have a unique site ID.

In other examples, a unique location-level data aggregation or “location” may include a plurality of sites 124. For instance, a multi-dwelling unit (MDU) may include a plurality of occupiable units, where each unit may include a separate network connection. Thus, the location may include a plurality of distinct sites 124 corresponding to the plurality of units of the MDU. According to aspects, the unique location-level data aggregations may reduce the amount of processing required to validate the existing network site data. For instance, searches for various data are performed with external data sources at the location level (e.g., unique set of street address and geocoordinates) rather than at the individual site-level (e.g., an apartment or suite number). Thus, the number of searches for matching external data are reduced. As an example, an MDU, such as a high-rise apartment complex, may have 100 units. Rather than performing 100 queries with each external data source (e.g., for each site 124 corresponding to each unit), the existing site data preprocessor 302 may aggregate the units into a location-level site aggregation, where a single query is performed for each external data source for the location (e.g., the apartment complex). According to examples, the existing site data preprocessor 302 may further record a number of sites 124 that are determined to be associated with each location-level data aggregation.

According to examples, the external data processor 304 may be in communication with one or more external data sources to acquire and match data from the one or more external data sources to existing network site data. The one or more external data sources, for example, may include one or more external occupancy data sources 322, one or more external geolocation data sources 324, one or more external address data sources 326, one or more external parcel data sources 328, one or more external building data sources 330, and one or more external business data sources 332. Other external data sources are possible and are within the scope of the present disclosure. In some examples, the external data processor 304 may access one or more of the external data sources via an Application Programming Interface (API) to request and obtain various external data.

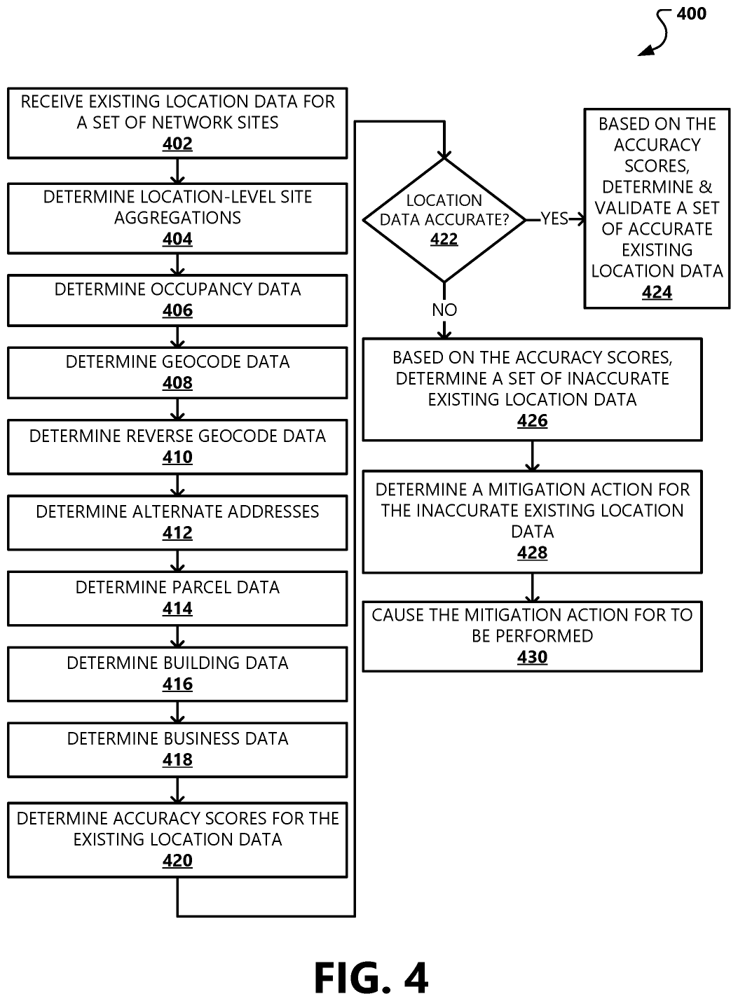

FIG. 4 is a flowchart that includes example operations of a method 400 for providing serviceable network site location validation and remediation according to an example. For example, one or more of the operations may be performed by components of the network site validation and remediation system 350. With reference now to FIG. 4, at operation 402, a set of location data for a plurality of sites 124 in a communications network 104 is received. For example, the network site validation and remediation system 350 may receive the location data as part of a request for validating the accuracy of the location data and remediating inaccurate data. In some examples, the location data includes addresses corresponding to service-enabled sites 124. In some examples, the location data alternatively or additionally includes geocoordinates corresponding to service-enabled sites 124.

At operation 404, location-level site aggregations may be determined. For example, the existing site data preprocessor 302 may preprocess received existing site location data and aggregate the data to location-level site aggregations or locations. According to an example, a location-level site aggregation includes a unique set of street address and geocoordinates) and may include one or more sites.

At operation 406, occupancy data for may be determined for a set of location-level site aggregations. In some examples, the external data processor 304 is configured to communicate with one or more external occupancy data sources 322 to obtain and match occupiable unit data from the one or more external occupancy data sources 322 to location data of the set of site locations. An example occupancy data source 322 may include a consumer data and/or demographic data source that is configured to provide information about the number of occupiable units associated with a particular location. For instance, for the example MDU described above, external occupancy data received from the one or more external occupancy data sources 322 may indicate that 100 occupiable units are associated with the street address and/or geocoordinates corresponding to the MDU. In some examples, for each of the location-level existing site data aggregations in the set, the external data processor 304 may provide the existing street address and/or geocoordinates included in the location data to the one or more external occupancy data sources 322. In response, the external data processor 304 may receive, for each location, the number of associated occupiable units.

At operation 408, external geolocation data (e.g., geocode data) may be determined for the set of location-level site aggregations. In some examples, the external data processor 304 may communicate with one or more external geolocation data sources 324 to determine external geolocation data (e.g., geocode and/or reverse geocode data) based on existing site location data. Example geolocation data sources 324 may include one or more private or public geocoders operable to receive addresses and output geocode coordinates that correspond to a given physical location. For example, one or more third parties may maintain geolocation information of the Earth, including topographical maps, satellite images, street information, and the like, which are mapped to latitude and longitude coordinate values. The third-party geolocation information may be made available to others via an API. For instance, the external data processor 304 may provide location addresses to one or more external geolocation data sources 324 to receive estimated latitude and longitude geocode coordinate values of the addresses. In some examples, one or more external geolocation data sources 324 may provide one or more satellite images or other maps of the area surrounding the provided addresses. In some examples, one or more external geolocation data sources 324 may further provide accuracy level information representing a level of confidence of the determined geocode coordinates matching the supplied address.

In some examples, one or more external geolocation data sources 324 may provide rooftop-level accurate geolocation data (e.g., geocode coordinates), and the accuracy level information may include an indication (e.g., a rooftop-level accuracy flag) that identifies the associated geolocation data as being rooftop-level accurate. For instance, rooftop-level accurate geolocation data may include geocoordinates of a building on a property determined to be located at a received existing location address.

At operation 410, reverse geolocation data (e.g., reverse geocode data) may be determined for the set of location-level site aggregations. In some examples, one or more external geolocation data sources 324 may provide reverse geocoding services, by which geocoordinates describing a location may be received and converted into an address. For example, the external data processor 304 may provide existing geocoordinates corresponding to the plurality of location-level existing site data aggregations to one or more external geolocation data sources 324. In response, the one or more external geolocation data sources 324 may determine and provide addresses that correspond to the existing geocoordinates. In some examples, one or more external geolocation data sources 324 may include, with the addresses, accuracy level information associated with the determined addresses, where the accuracy level information may represent a level of confidence of the determined address matching the supplied geocoordinates. For instance, the address may be determined to be associated with a building located at the received geolocation coordinates.

At operation 412, alternate addresses may be determined for the set of location-level site aggregations. In some examples, the external data processor 304 may communicate with one or more external address data sources 326 to determine possible alternate addresses to existing addresses of the plurality of location-level existing site data aggregations. For instance, alternate addresses may include addresses that are determined as closely matched to existing location addresses based on specified criteria. Alternate addresses may include addresses that may not be matched to a location address due to various common matching errors. For instance, more than one city or town name may be associated with a particular street address in various external data sources, street names may be misspelled, and the like. Thus, in some examples, the external data processor 304 communicate with one or more external address data sources 326 to request and obtain a set of addresses within a threshold distance (e.g., nearby addresses, such as addresses with a 100 ft, 250 ft, or 500 ft radius) of an existing location address. The external data processor 304 may further perform one or more address matching processes to determine whether any of the obtained addresses that are within the threshold distance “match” the existing location address based on specified criteria. For instance, the external data processor 304 may utilize fuzzy string matching and/or abbreviation tables to determine a match score of a nearby address to the existing location address based on the specified criteria. In some examples, the external data processor 304 may use the Levenshtein distance method to determine the match score of a string match between a nearby address and an existing location address. A nearby address with a match score above a defined threshold may be determined as a possible alternate address to the existing location address (and associated site addresses). In some examples, the external data processor 304 may determine alternate addresses based on whether house numbers of a nearby address and existing address match exactly. As an example, 123 N Main St may be determined as a possible alternate address to 123 Main St, while 124 Main St may not be determined as a possible alternate address.

At operation 414, parcel data may be determined for the set of location-level site aggregations. Parcel data, for example, may include geocoordinates of the outer boundaries of a parcel corresponding to a location's address. In some examples, the external data processor 304 may communicate with one or more external parcel data sources 328 to determine parcel data corresponding to existing location data. For instance, the external data processor 304 may provide addresses corresponding to the plurality of location-level data aggregations to one or more external parcel data sources 328 and request parcel data associated with the existing location addresses. In some examples, parcel data received from one or more external parcel data sources 328 may indicate more than one parcel matches existing geolocation location data. In such cases, as part of determining parcel data, the external data processor 304 may select a smallest sized parcel as a closest match. If multiple similarly sized parcels match existing location data, the external data processor 304 may select the parcel with the best string match (e.g., highest match score) between the addresses. Determining the string match score between addresses may utilize methods including but not limited to the Levenshtein distance method.

At operation 416, building data may be determined for the set of location-level site aggregations. Building data, for example, may include geocoordinates associated with a footprint of one or more buildings located at an address, where the geocoordinates may represent a point (e.g., a central point) or outer boundaries of a building footprint. In some examples, the external data processor 304 may communicate with one or more external building data sources 330 to determine building data based on existing location data. In some examples, the external data processor 304 may provide addresses and/or geocoordinates corresponding to the plurality of location-level data aggregations to one or more external building data sources 330 and request and receive building data associated with the corresponding locations.

At operation 418, business data may be determined for the set of location-level site aggregations. Business data, for example, may include addresses of businesses (e.g., including small businesses) located within a threshold distance of an address corresponding to a location-level data aggregation. For instance, businesses within a threshold distance of a site 145 may be identified to provide validation of the existing location data in cases where there are more units than the occupancy data would suggest. In some examples, the external data processor 304 may provide existing location data (e.g., addresses and/or geocoordinates) corresponding to the plurality of location-level data aggregations to one or more external business location data sources 332 and request and receive business location data within a threshold distance of the locations.

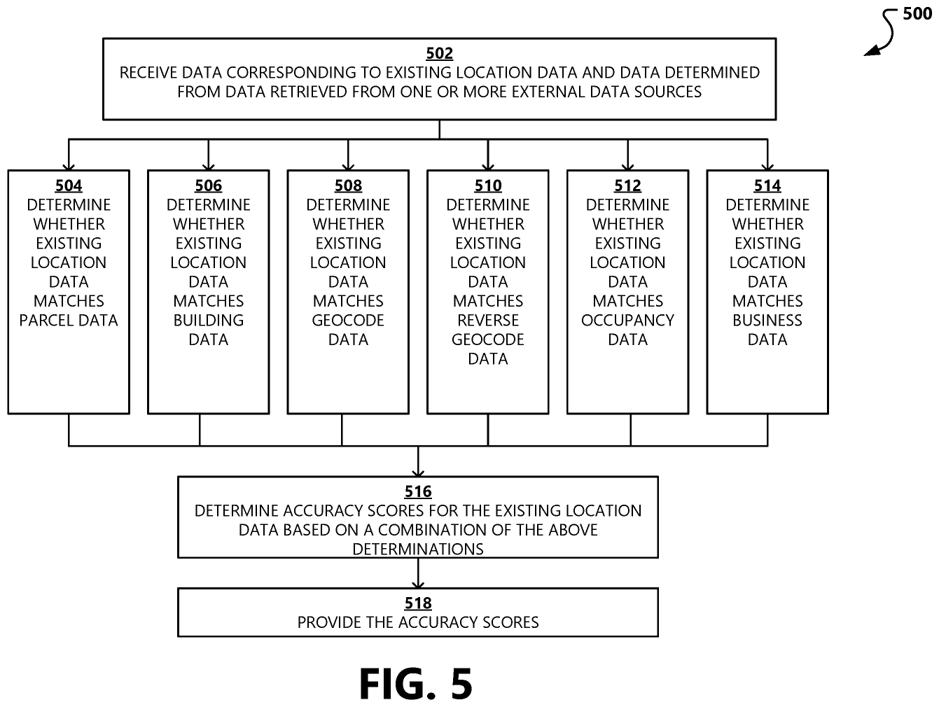

At operation 420, accuracy scores may be determined for the existing location data corresponding to the set of location-level site data aggregations. The accuracy scores provide a measure of confidence that the location data (e.g., address and/or geocoordinates) of a site 124 accurately reflects the physical location where a network connection is provided and thus, where service exists or potentially can be deployed. According to some examples, accuracy scores may be determined based on an evaluation of a combination of the above-determined data using various heuristic rules. Example rules are described below with reference to FIGS. 5-12. In some examples, accuracy scores may be based on at least two of: determining whether the existing location data matches parcel data, building data, geocode data, reverse geocode data, occupancy data, and/or business data.

At decision operation 422, a determination may be made as to whether existing location data is accurate based on the determined accuracy scores. In some examples, an accuracy score determined for a location-level site data aggregation may be evaluated against an accuracy threshold, where the accuracy threshold is represented as a numeric value within a range of numeric values, a classification within a range of classifications (e.g., low, medium, and high classifications), or the like. For instance, accuracy scores above the accuracy threshold are determined to satisfy the accuracy threshold, thus indicating a high level of confidence that the existing address and/or geocoordinates associated with one or more sites 124 at the location are accurate. At operation 424, location data with an accuracy score that satisfies the accuracy threshold is determined to be accurate and may be validated as being in a usable format for one or more downstream processes (e.g., a purchase flow, reporting of service-enabled units, etc.). In some examples, the location data may be stored and marked as accurate with a timestamp of when the accuracy of the location information was last verified. In some examples, stored, verified location data may be scheduled for periodic re-verification based on such timestamp.

Alternatively, an accuracy score below the accuracy threshold (e.g., a numeric value, a low or medium classification) may be determined to not satisfy the accuracy threshold, indicating that the corresponding existing address and/or geocoordinates associated of the site(s) 124 may be inaccurate. For example, when the accuracy score is determined to not satisfy the accuracy threshold, at operation 426, a set of inaccurate existing location data is determined and then further processed as explained below.

At operation 428, one or more mitigation actions may be determined for location data that is determined to be inaccurate. In some examples, the site location mitigator 310 is configured to receive the determinations made by the accuracy scoring engine 306 and determine one or more mitigation actions to be performed. At operation 430, the one or more mitigation actions may be performed. For example, a mitigation action may include one or a combination of: determining alternate site location data, updating existing site location data stored in one or more network site data sources 320, notifying an administrative user or third party to further analyze inaccurate existing site location data, etc. For instance, incorrect existing site location data may be removed and/or updated to correct location data to ensure location-data consumers (e.g., other people or processes) are utilizing correct location information. Example mitigation actions are described below.

FIG. 5 is a flowchart depicting operations of a method 500 for providing serviceable network site location validation and remediation according to an example. For example, one or more of the operations may be performed by the accuracy scoring engine 306 of the network site validation and remediation system 350. In some examples, operations included in FIG. 5 may be performed in operation 420 in the example method 400 depicted in FIG. 4. With reference now to FIG. 5, at operation 502, a set of location data for a plurality of sites 124 in a communications network 104 is received. In some examples, the location data includes addresses corresponding to service-enabled sites 124. In some examples, the location data alternatively or additionally includes geocoordinates corresponding to service-enabled sites 124. In some examples, data determined by the external data processor 304 is also received at operation 502. For example, the accuracy scoring engine 306 may receive determined occupancy data, geocode data, reverse geocode data, alternate addresses, parcel data, building data, and business data associated with the existing location data for the plurality of sites 124. In some examples, a combination of various evaluations may be performed for determining accuracy scores for the existing location data for the plurality of sites 124. In some examples, at least two of the following example evaluations may be performed for determining the accuracy scores. In other examples, additional, fewer, and/or alternate rules/evaluations may be used for determining existing network site data validity, for instance, depending on business needs.

At operation 504, for each location, a determination may be made as to whether parcel data matches existing location data. For example, in some implementations, the accuracy scoring engine 306 may determine a parcel match score for measuring a degree of match between parcel data determined by the external data processor 304 (e.g., as described above with reference to operation 414 of method 400) and existing location data. In some examples, the parcel match score is determined based at least in part on whether the existing geocoordinates for a location are within the outer boundaries of the associated parcel by a threshold distance. For instance, geocoordinates that are determined to be located within the outer parcel boundaries may be assigned a higher parcel match score, indicating a higher level of match. Alternatively, geocoordinates that are determined to be located outside the outer parcel boundaries may be assigned a lower parcel match score that indicate a lower level of (or no) match.

At operation 506, for each location, a determination may be made as to whether building data matches existing location data. For example, in some implementations, the accuracy scoring engine 306 may determine a building match score for measuring a degree of match between building data determined by the external data processor 304 (e.g., as described above with reference to operation 416 of method 400) and existing location data. In some examples, the building match score is determined based at least in part on whether the geocoordinates corresponding to the existing site location data are within or near the footprint of the one or more buildings. For instance, the external data processor 304 may determine whether the existing geolocation coordinates of a location-level site data aggregation are within a threshold distance of a point or outer boundaries of a building located at the location. For instance, geocoordinates that are determined to be located within the outer building boundaries may be assigned a higher building match score, indicating a higher level of match. Alternatively, geocoordinates that are determined to be located outside the outer building boundaries may be assigned a lower building match score that indicate a lower level of (or no) match.

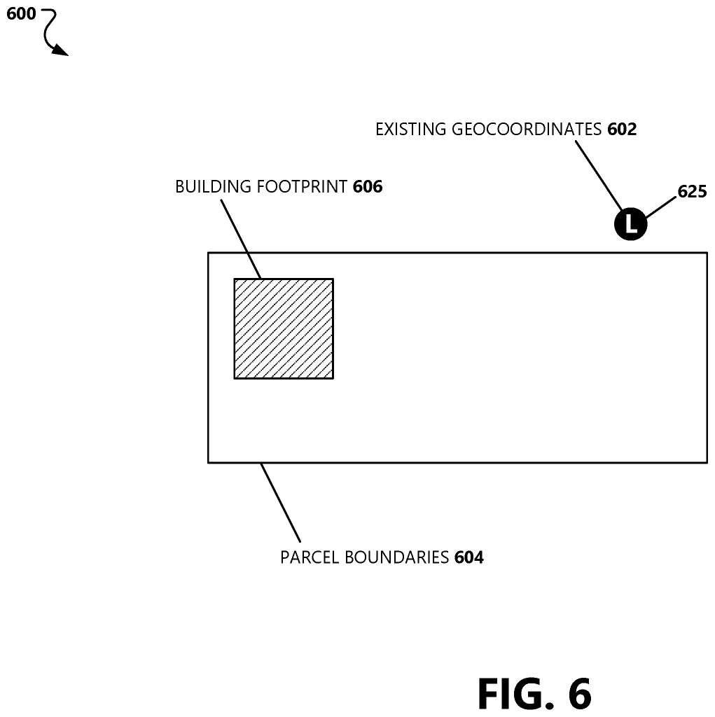

For instance in the example 600 depicted in FIG. 6, when a determination is made that existing geocoordinates 602 of a location-level site aggregation are not within parcel boundaries 604 by a first threshold distance and that a building footprint 606 is not within a second threshold distance of the existing geocoordinates 602, the accuracy scoring engine 306 may have a lower level of confidence that the existing location data (e.g., address and/or geolocation coordinates 602) is accurate. Thus, for example, the accuracy scoring engine 306 may determine low building match score for the existing location data. According to an example, the low building match score may cause the accuracy score 625 to be below an accuracy threshold (e.g., a low or medium accuracy classification), indicating that the existing location data associated with the one or more sites 124 at the location may be inaccurate and/or that the existing location data may need to be further analyzed.

With reference again to the example method 500 depicted in FIG. 5, at operation 508, for each location, a determination may be made as to whether geocode data matches existing location data. For example, in some implementations, the accuracy scoring engine 306 may determine a geocode match score for measuring a degree of match between geocode data determined by the external data processor 304 (e.g., as described above with reference to operation 408 of method 400) and existing location data. In some examples, the geocode match score is determined based at least in part on a geographic distance between geocode coordinates received from one or more external geolocation data sources 324 and existing location geocoordinates. For instance, the external data processor 304 may determine whether the existing geocoordinates of a location-level site data aggregation are within a threshold distance of one or more geocode coordinates. For instance, geocoordinates that are determined to be located within the threshold distance of one or more sets of geocode coordinates may be assigned a higher geocode match score, indicating a higher level of match. Alternatively, geocoordinates that are determined to be located outside the threshold distance may be assigned a lower geocode match score that indicate a lower level of (or no) match.

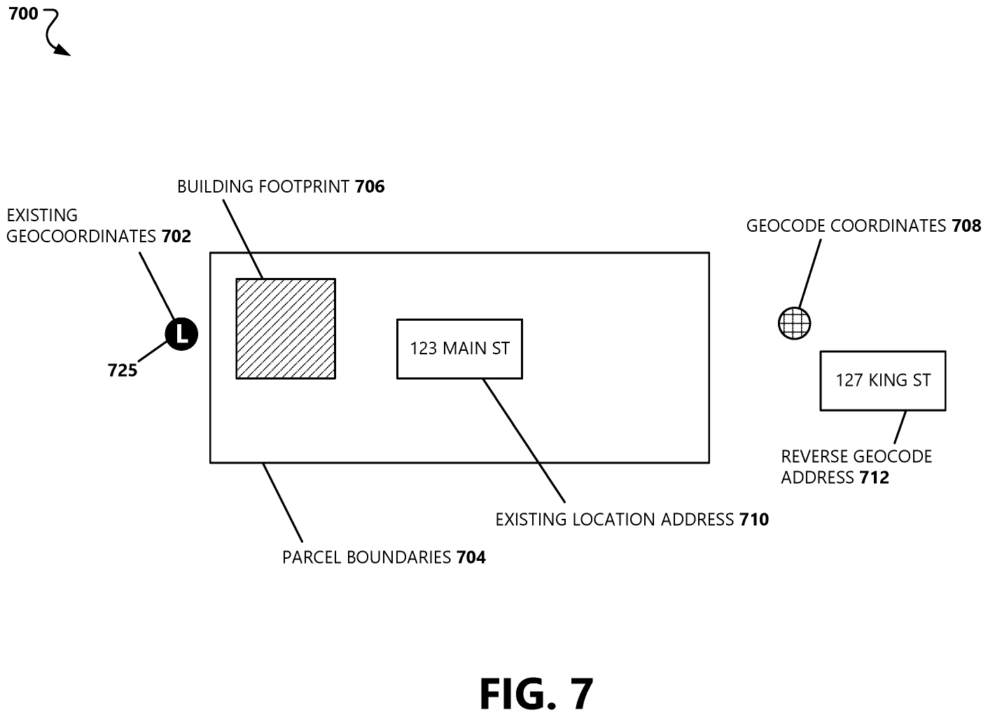

For instance, in the example 700 depicted in FIG. 7, when a determination is made that existing geocoordinates 702 of a location-level site aggregation are not within a first threshold distance of geocode coordinates 708 received from an external geolocation data source 324, the accuracy scoring engine 306 may have a lower level of confidence that the existing location data is accurate. Thus, for example, the accuracy scoring engine 306 may determine a low geocode match score for the existing location data. According to an example, the low geocode match score may cause the accuracy score 725 to be below an accuracy threshold (e.g., a low or medium accuracy classification), indicating that the existing location data associated with the one or more sites 124 at the location may be inaccurate and/or that the existing location data may need to be further analyzed.

With reference again to FIG. 5, at operation 510, for each location, a determination may be made as to whether reverse geocode data matches existing location data. For example, in some implementations, the accuracy scoring engine 306 may determine a reverse geocode match score for measuring a degree of match between reverse geocode data determined by the external data processor 304 (e.g., as described above with reference to operation 410 of method 400) and existing location data. In some examples, the reverse geocode match score is determined based at least in part on results of one or more address matching processes used to determine whether reverse geocode data (e.g., an address obtained from existing geocoordinates of a location) is within a threshold distance of existing address data. For instance, the external data processor 304 may utilize fuzzy string matching and/or abbreviation tables to determine a reverse geocode match score of a reverse geocode address to the existing location address based on specified criteria. In some examples, the external data processor 304 may use the Levenshtein distance method to determine the match score of a string match between a reverse geocode address and an existing location address. A reverse geocode address with a match score above a defined threshold may be assigned a higher reverse geocode match score, indicating a higher level of match. Alternatively, a reverse geocode address with a match score below the defined threshold may be assigned a lower reverse geocode match score indicating a lower level of (or no) match. In some examples, the external data processor 304 may determine the reverse geocode match score based at least in part on whether house numbers/street address of a reverse geocode address and existing location address match exactly. As an example, a determination that house numbers/street address do not match exactly may cause the external data processor 304 to assign a lower reverse geocode match score.

For instance, and as further depicted in FIG. 7, a determination may be made that an existing location address 710 does not match a determined reverse geocode address 712 (e.g., an address determined by reverse geocoding). As a further example, a determination may be made that the existing geocoordinates 702 do not match the parcel data (e.g., the existing geocoordinates 702 are outside a threshold distance of parcel boundaries 704 of the parcel) determined for the location. As another example, a determination may be made that the existing location geocoordinates 702 do not match the building data (e.g., the existing geocoordinates 702 are outside a threshold distance of a building footprint 706) determined for the location. For instance, the existing geocoordinates 702 may be outside a threshold distance of a point or outer boundaries of the building footprint 706. As an example, when a combination of the above example determinations is made, the accuracy scoring engine 306 may determine that the existing geolocation data (e.g., existing location address 710 address and/or existing geocoordinates 702) associated with a location-level data aggregation have a low reverse geocode match score. According to an example, the low reverse geocode match score may cause the accuracy score 725 to be below an accuracy threshold (e.g., a low or medium accuracy classification), indicating the existing location data associated with the one or more sites 124 at the location may be inaccurate and/or that the existing location data may need to be further analyzed.

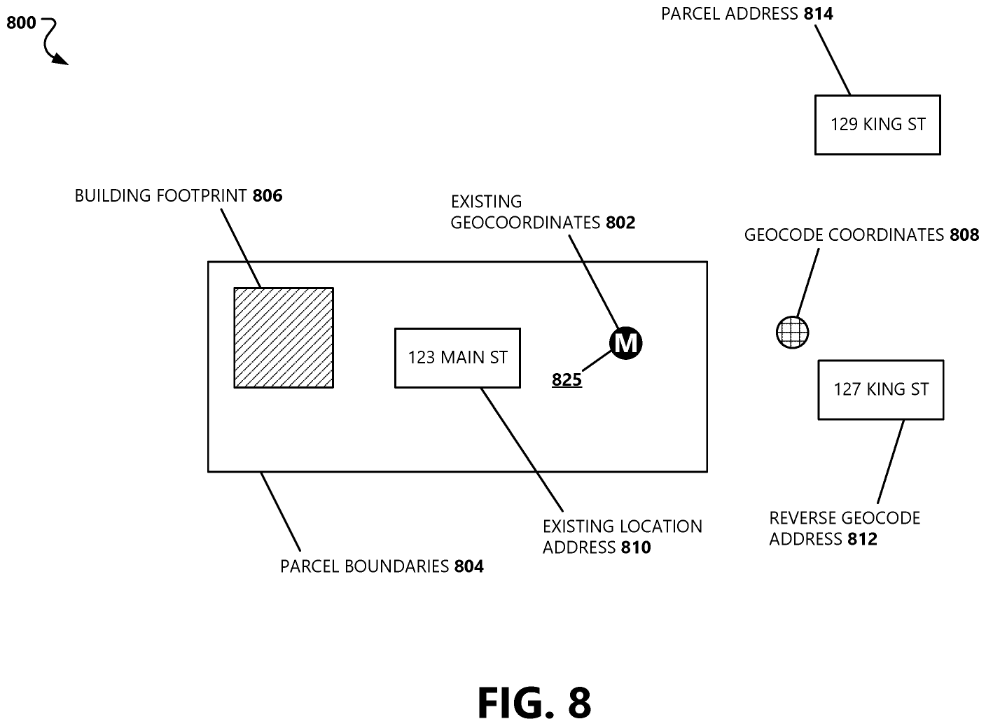

According to another example 800 depicted in FIG. 8, a determination may be made that existing location data may match parcel data but not match building data. For example, existing geocoordinates 802 may be within parcel boundaries 804 by a first threshold distance but outside a second threshold distance to a point or outside boundaries of a building footprint 806. As another example, a determination may be made that existing location data may match parcel data but building data indicate that there is no building identified within the parcel boundaries 804 or within the second threshold distance.

As another example, a determination may be made that existing geocoordinates 802 may be within parcel boundaries 804 by the first threshold distance, but the existing location address 810 and the address of the parcel (e.g., as used by one or more external parcel data sources 328), which is herein referred to as a parcel address 814, may not match. For example, the parcel match score may be determined based at least in part on results of one or more address matching processes to determine whether the parcel address 814 matches the existing location address 810 within a match score threshold (e.g., as determined using methods described above). As another example, a determination may be made that the existing location address 810 may not match a reverse geocode address 812 (e.g., an address determined by reverse geocoding) within a match score threshold (e.g., as determined using one or more address matching processes). As an example, when a combination of the above determinations is made, the accuracy scoring engine 306 may determine that the existing location data (e.g., existing location address 810 address and/or existing geocoordinates 802) associated with the location-level data aggregation has a medium accuracy score 825. For instance, the medium accuracy score 825 may be below an accuracy threshold, indicating that the existing location data associated with the one or more sites 124 at the location may be inaccurate and/or that the existing location data may need to be further analyzed.

With reference again to the example method 500 depicted in FIG. 5, at operation 512, for each location, a determination may be made as to whether occupancy data determined by the external data processor 304 (e.g., as described above with reference to operation 406 of method 400) matches existing site unit count data. In some examples, a determination may be made as to whether existing location data (e.g., an address or geocoordinates) match any occupancy data addresses/geocoordinates. In some implementations, the accuracy scoring engine 306 may further determine an occupancy match score for measuring a degree of match between an occupiable unit count received from the one or more external occupancy data sources 322 and a number of sites 124 associated with each location-level data aggregation.

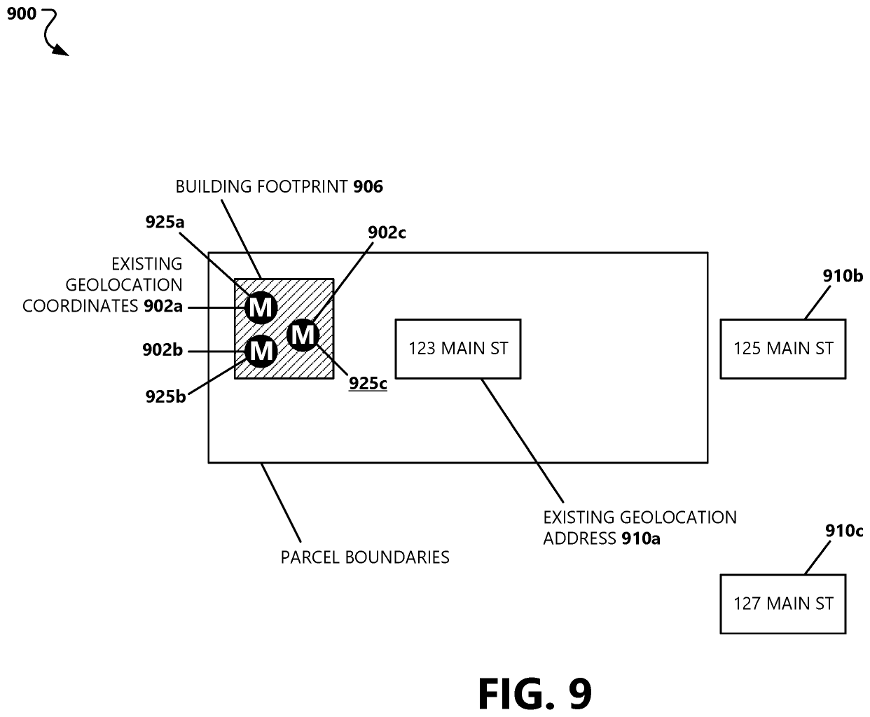

According to an example 900 depicted in FIG. 9, a determination may be made that location data corresponding to a plurality of locations include a plurality of existing geolocation coordinates 902a, 902b, and 902c within a threshold distance of a same building footprint 906. However, another determination may be made that the plurality of existing geolocation coordinates 902a, 902b, and 902c do not share a same existing location address 910a, 910b, and 910c. As an example, the above determinations may cause the accuracy scoring engine 306 to determine that the existing location data for each location-level data aggregation corresponding to the existing geolocation coordinates 902a, 902b, and 902c may have a low geocode match score for the existing location data. According to an example, the low geocode match scores may cause the accuracy scores 925a, 925b, and 925c to be below an accuracy threshold (e.g., a low or medium accuracy classification), indicating that the existing location addresses 910a-c, existing location geocoordinates 902a-c, or site unit count data associated with the one or more sites 124 in the location-level data aggregations may be inaccurate and/or that the existing location data may need to be further analyzed.

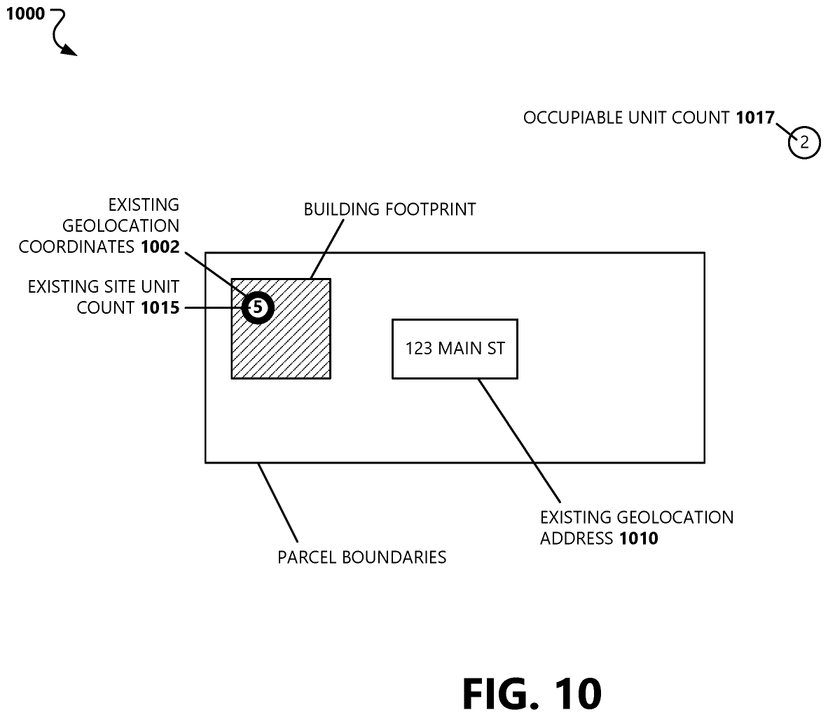

According to another example 1000 and with reference now to FIG. 10, a determination may be made whether existing location data corresponding to a location include a site unit count 1015 that matches an occupiable unit count 1017 of a building determined based on occupancy data obtained from one or more external occupancy data sources 322. As an example, and as depicted in FIG. 10, a determination may be made that the existing location data includes an existing site unit count 1015 that does not match the occupiable unit count 1017. For instance, the location may have more sites 124 than indicated by the occupancy data. When the above determination is made, the accuracy scoring engine 306 may determine a low occupancy match score for the existing location data. According to an example, the low occupancy match score may cause the accuracy score to be below an accuracy threshold (e.g., a low or medium accuracy classification), indicating that the existing location data may be inaccurate and may need to be further analyzed. For example, when the existing site unit count 1015 does not match the occupiable unit count 1017, a determination may be made that there may be duplication or invalid units corresponding to sites 124 in the location-level data aggregation that need to be evaluated and corrected.

With reference again to the example method 500 depicted in FIG. 5, at operation 514, for each location, a determination may be made as to whether business data determined by the external data processor 304 (e.g., as described above with reference to operation 418 of method 400) indicate a business, such as a small business, is within a threshold distance of the location. In some implementations, the accuracy scoring engine 306 may determine a business match score for measuring a number of businesses within the threshold distance of the location. In some examples, the business match score is used to provide validation of accuracy of existing location data, for instance, in cases where the existing location data may be flagged as low confidence due to a low occupancy score. For example, a business with an apartment above it will be two units, but occupancy data sources may show only one occupiable unit. This may otherwise comprise a low confidence situation because there are two units in a building with only one occupiable unit, but the presence of a nearby business indicates that the second unit is likely a business and thus not in the occupiable unit data. As such, the existing location data showing two units is possibly correct, causing the confidence score to be increased from low to medium, for example.

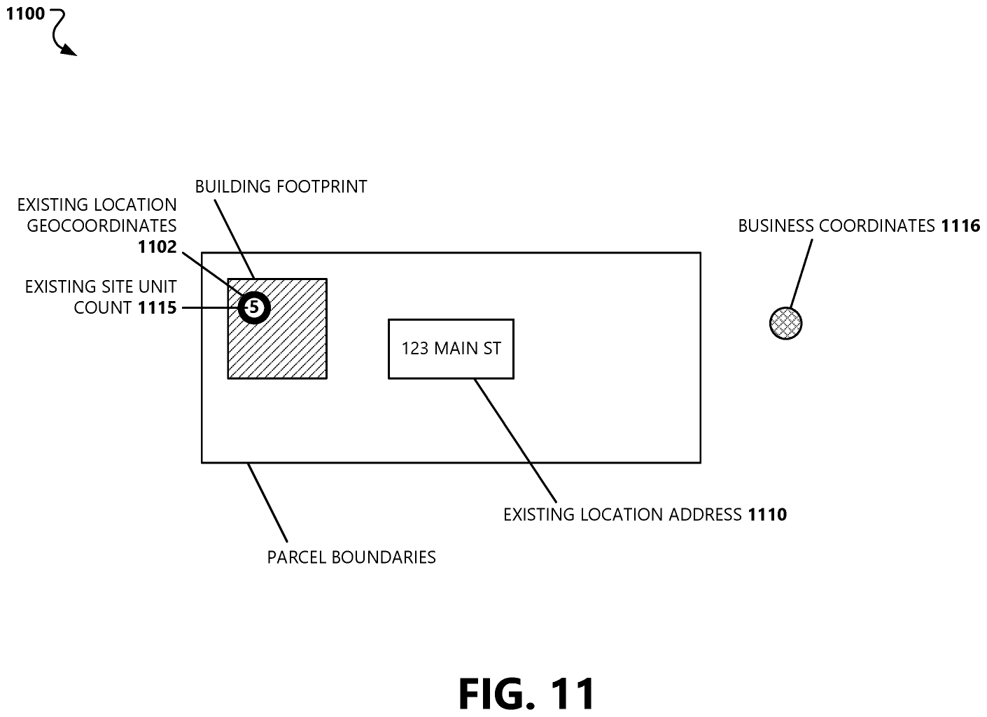

For instance, and with reference now to an example 11 depicted in FIG. 11, a determination may be made whether occupancy data obtained from any external occupancy data source 322 indicates that the existing location data (e.g., address or geocoordinates) match any occupancy data addresses/geocoordinates. According to an example, a determination may be made that the existing location data is not found in any external occupancy data source 322. According to another example, a determination may be made that a plurality of sites 124 share the same address (e.g., the location-level data aggregation is associated with a plurality of sites 124). For instance, the site unit count 1115 associated with the location may be 5 sites (e.g., a building at the location may be an MDU). According to another example, a determination may be made that a business may not be located within a threshold distance of the location based on business location data (e.g., business coordinates 1116 or addresses) obtained from one or more external business data sources 332. For instance, when a combination of the above determinations are made, the accuracy scoring engine 306 may determine that the existing location data (e.g., existing location address 1110 address and/or existing geocoordinates 1102) associated with the location has a lower level of accuracy (e.g., a medium accuracy score 1125). In some examples, a medium accuracy score 1125 may be below a confidence threshold, indicating that the existing location data associated with the plurality of sites 124 may be inaccurate and/or that the existing location data may need to be further analyzed.

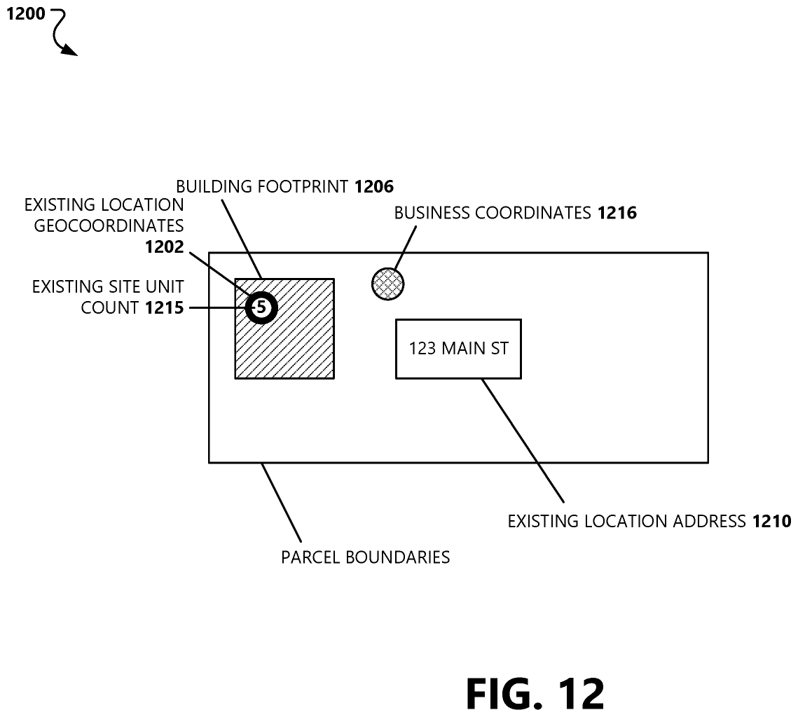

With reference now to another example 12 depicted in FIG. 12, a determination may be made whether occupancy data obtained from any external occupancy data source 322 indicates that the existing location data (e.g., address or geocoordinates) match any occupancy data addresses/geocoordinates. According to an example, a determination may be made that the existing location data is not found in any external occupancy data source 322. As another example, a determination may be made that one or more businesses may be located within a threshold distance of the location based on business location data (e.g., business coordinates 1216 or addresses) obtained from one or more external business data sources 332. According to another example, a determination may be made that a plurality of sites 124 share the same address (e.g., the location-level data aggregation is associated with a plurality of sites 124). For instance, the site unit count 1215 associated with the location may be 5 sites (e.g., a building at the location may be an MDU). According to an example, when a combination of the above determinations is made, the accuracy scoring engine 306 may determine that the existing location data (e.g., existing location address 1210 address and/or existing geocoordinates 1202) associated with the location has a lower level of confidence (e.g., a medium accuracy score 1225). In examples, the medium accuracy score 1225 may be below a confidence/accuracy threshold, indicating that the existing location data associated with the plurality of sites 124 may be inaccurate and/or that the existing location data may need to be further analyzed.

With reference again to the example method 500 depicted in FIG. 5, at operation 516, for each location, an accuracy score corresponding to the location data accuracy is determined. For example, the accuracy score may be determined based on a combination (e.g., at least 2) of the determinations made in operations 504-514 (e.g., whether (and to what extent) the existing location data matches parcel data, building data, geocode data, reverse geocode data, occupancy data, and/or business data. As described above, the accuracy score may provide a measure of confidence that a site's location data (e.g., address and/or geocoordinates) accurately reflects the physical location where a network connection is provided (or providable) and thus, where service exists or potentially can be deployed. At operation 518, the determined accuracy scores may be output. For example, the accuracy scoring engine 306 may provide the accuracy scores of the existing location data to the site location mitigator 310. For example, the site location mitigator 310 may receive determinations made by the accuracy scoring engine 306 and determine and cause one or more mitigation actions to be performed. Example mitigation actions may include one or a combination of: determining alternate site location data, updating existing site location data stored in one or more network site data sources 320, notifying an administrative user or third party to further analyze inaccurate existing site location data, etc.

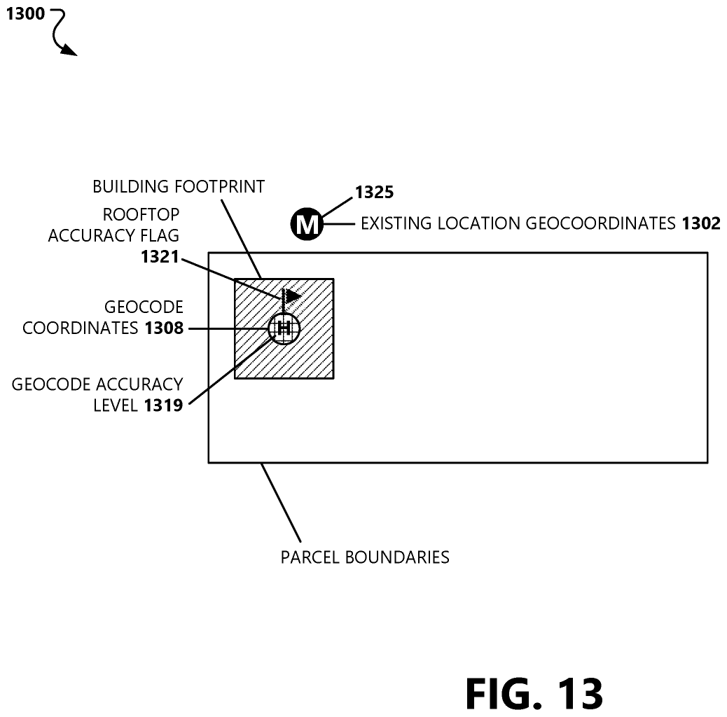

With reference now to an example 1300 depicted in FIG. 13, the site location mitigator 310 may use various rules to determine whether a location has an accuracy score 1325 below a specified accuracy/confidence threshold (e.g., a medium or low accuracy score classification) and to determine alternate geocoordinates for the location when the determination is made. For instance and as shown, the existing location geocoordinates 1302 may be determined to have a medium accuracy score 1325, which may indicate to that alternate coordinates may be determined for the location. Alternatively, when the existing location geocoordinates 1302 are determined to have a high accuracy score 1325, a decision may be made that alternate coordinates need not be determined.

In some examples, the site location mitigator 310 may further determine whether geocode coordinates 1308 received from one or more external geolocation data sources 324 meet a match threshold. According to an example implementation, when geocode coordinates 1308 are received from only one external geolocation data source 324 for the location, a determination may be made whether the geocode coordinates 1308 have a geocode accuracy level 1319 above a specified accuracy level threshold and/or whether accuracy level information received with the geocode coordinates 1308 includes an indication (e.g., a rooftop-level accuracy flag 1321) identifying the geocode coordinates as being rooftop-level accurate. When the geocode coordinates 1308 satisfy the accuracy level threshold and/or are rooftop-level accurate, the geocode coordinates 1308 may be determined to be the alternate coordinates to the existing geolocation coordinates 1302.

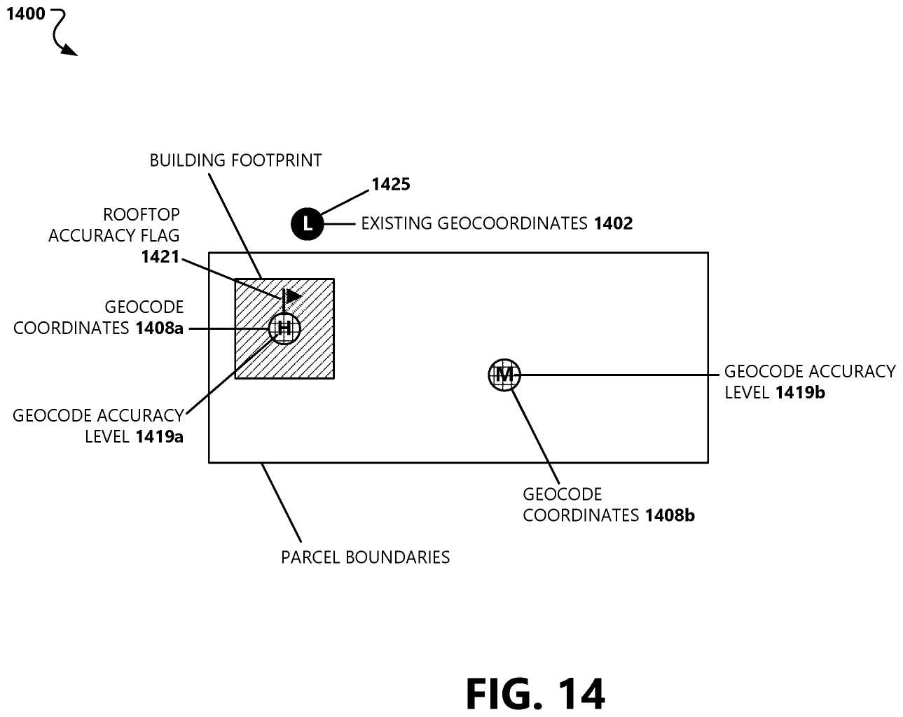

In other examples, and as depicted in FIG. 14, geocode coordinates 1408a and 1408b may be received from at least two external geolocation data sources 324 for the location. Thus, a determination may be made as to which geocode coordinates 1408a and 1408b have a higher geocode accuracy level 1419a and 1419b. For example, and as depicted in FIG. 14, a first set of geocode coordinates 1408a may have a high geocode accuracy level 1419a and may be rooftop-level accurate (e.g., may include a rooftop-level accuracy flag 1421). As such the first set of geocode coordinates 1408a may be used instead of the second set of geocode coordinates 1408b as the alternate coordinates.

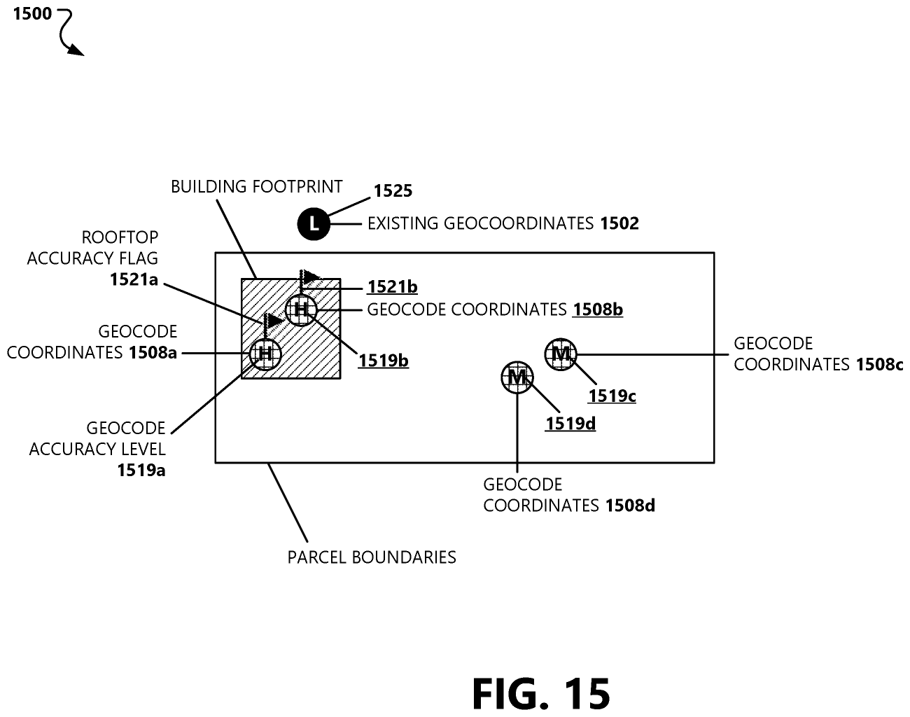

According to another example 1500 depicted in FIG. 15, in some examples, multiple sets of geocode coordinates 1508a-1508d are obtained from a plurality of external geolocation data sources 324 and geocode accuracy levels 1519a-1519d may be determined for each set of geocode coordinates. In some examples, coordinates within a predefined distance of one another (e.g., within a 25-foot radius, a 36-foot radius, or a 100-foot radius of each other) may be grouped. According to examples, a group may include one or a combination of existing geocoordinates 1502 and geocode coordinates 1508a-1508d. In some examples, a determination may be made as to which group is a largest group of coordinates that have geocode accuracy levels 1519a-1519d above an accuracy level threshold (and/or accuracy classification/accuracy score for existing geocoordinates). In some examples, if the existing geocoordinates 1502 are included in the largest group and the accuracy score 1525 of the existing geocoordinates 1502 is above a predetermined threshold (e.g., an accuracy classification/accuracy score corresponding to a high confidence level of accuracy), the existing geocoordinates 1502 may be determined as the best match for the location (e.g., alternate site location data is not determined for the location). Alternatively, a set of coordinates included in the determined largest group may be selected based on a highest ranked (e.g., according to preference) external geolocation data source 324. For instance, external geolocation data sources 324 may be included in and ranked amongst a configurable list of preferred external geolocation data sources 324. In some implementations, the list is created and/or the external geolocation data sources 324 are ranked based on one or more preference selections. As an example, one preference selection may be to give higher preference to external geolocation data sources 324 that provide rooftop-level accurate geocode coordinates 1508a and 1508b (e.g., geocode coordinates include a rooftop-level accuracy flag 1521a and 1521b). In other examples, preference may vary based on other factors.

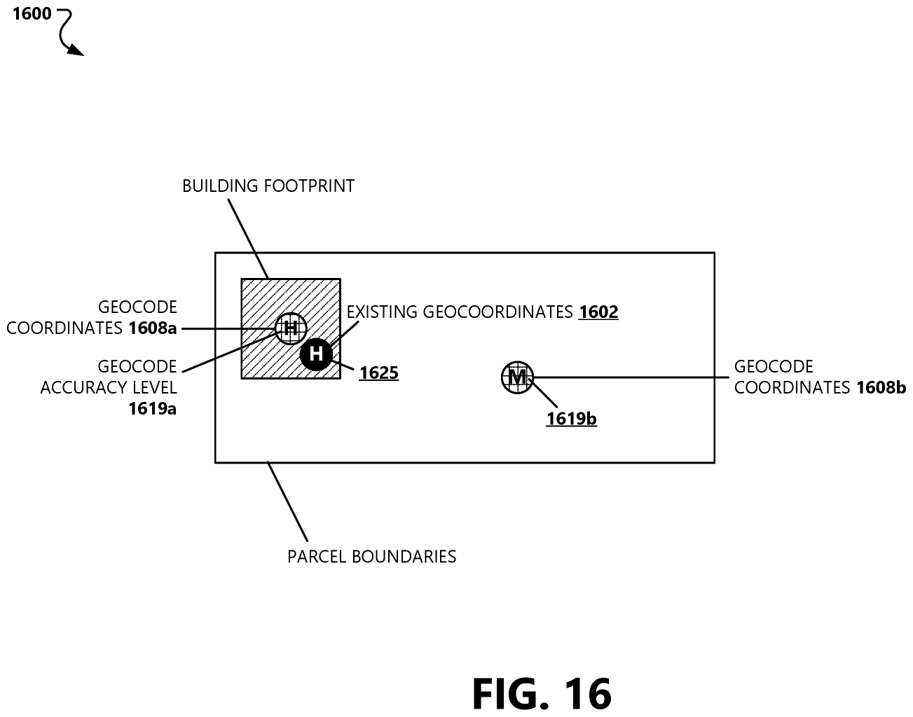

With reference now to the example 1600 depicted in FIG. 16, existing location geocoordinates 1602 are determined to have a high accuracy score 1625. Thus, although a first set of geocode coordinates 1608a have a high geocode score, a decision may be made that the existing location geocoordinates 1602 may not be replaced with alternate coordinates. Other example rules for determining accuracy scores may be used.

In some examples, the network site validation and remediation system 350 may be further configured to validate alternate geocoordinates. For instance, for each location for which alternate location data was determined, the external data processor 304 may acquire and match data from external data sources to the alternate coordinates and/or alternate address using various method described above. For example, the external data processor 304 may determine external occupancy data for a location corresponding to the alternate location data (e.g., such as in operation 406 of method 400). The external data processor 304 may further determine external geocode data for the location corresponding to the alternate location data (e.g., such as in operation 408 of method 400). The external data processor 304 may further determine reverse geocode data for the location corresponding to the alternate location data (e.g., such as in operation 410 of method 400). The external data processor 304 may further determine sub-alternate addresses for the location corresponding to the alternate location data (e.g., such as in operation 412 of method 400). The external data processor 304 may further determine parcel data for the location corresponding to the alternate location data (e.g., such as in operation 414 of method 400). The external data processor 304 may further determine building data for the location corresponding to the alternate location data (e.g., such as in operation 416 of method 400). The external data processor 304 may further determine business data for the location corresponding to the alternate location data (e.g., such as in operation 418 of method 400).

In some examples, the accuracy scoring engine 306 may evaluate the data determined by the external data processor 304 and make various determinations and to determine accuracy scores for the alternate location data. In some examples, the accuracy scoring engine 306 may determine whether alternate location data matches the determined parcel data for the location (e.g., such as in operation 504 of method 500). In some examples, the accuracy scoring engine 306 may determine whether alternate location data matches the determined building data for the location (e.g., such as in operation 506 of method 500). In some examples, the accuracy scoring engine 306 may determine whether alternate location data matches the determined geocode data for the location (e.g., such as in operation 508 of method 500). In some examples, the accuracy scoring engine 306 may determine whether alternate location data matches the determined reverse geocode data for the location (e.g., such as in operation 510 of method 500). In some examples, the accuracy scoring engine 306 may determine whether alternate location data matches the determined occupancy data for the location (e.g., such as in operation 512 of method 500). In some examples, the accuracy scoring engine 306 may determine whether alternate location data matches the determined business data for the location (e.g., such as in operation 512 of method 500).

In some examples, a determination may be made as to whether alternate location data is accurate based on accuracy scores determined according to a combination of above-described rules (e.g., such as in operation 516 of method 500) to evaluate various aspects of the alternate location data. In some examples, a determination may be made as to whether a sub-alternate address determined for a location is more than a threshold distance from the alternate address determined for the location. When the sub-alternate address and the alternate address are over the threshold distance apart, the network site validation and remediation system 350 may be further configured to validate the sub-alternate geocoordinates for the location.

In some examples, the site location mitigator 310 may be configured to automatically replace existing geocoordinates with the determined alternate (or sub-alternate) coordinates. For instance, alternate location data may replace existing location data in one or more network site data sources 320, thus replacing incorrect/less-accurate data with updated verified accurate location data. The alternate location data may be associated with the one or more site ID's of the sites 124 included in the location-level data aggregation. In other examples, the site location mitigator 310, may be configured to generate a notification corresponding to the existing geocoordinates and the determined alternate coordinates. For instance, the notification may be displayed to an administrative user to remove incorrect or less-accurate existing geocoordinates from one or more network site data sources 320 and replace the incorrect/less-accurate data with updated verified accurate location data. Thus, new serviceable location data may be added to one or more network site data sources 320 based on the verified accurate data determined for a site 124. As such, customers/site managers may be enabled to order and receive communications services through an uninterrupted purchase flow, where previously they may have not qualified for service due to the incorrect/less-accurate existing geocoordinates. Additionally, accuracy of internal and external reporting may be increased as the accuracy of the site data on which the reporting is based is verified.

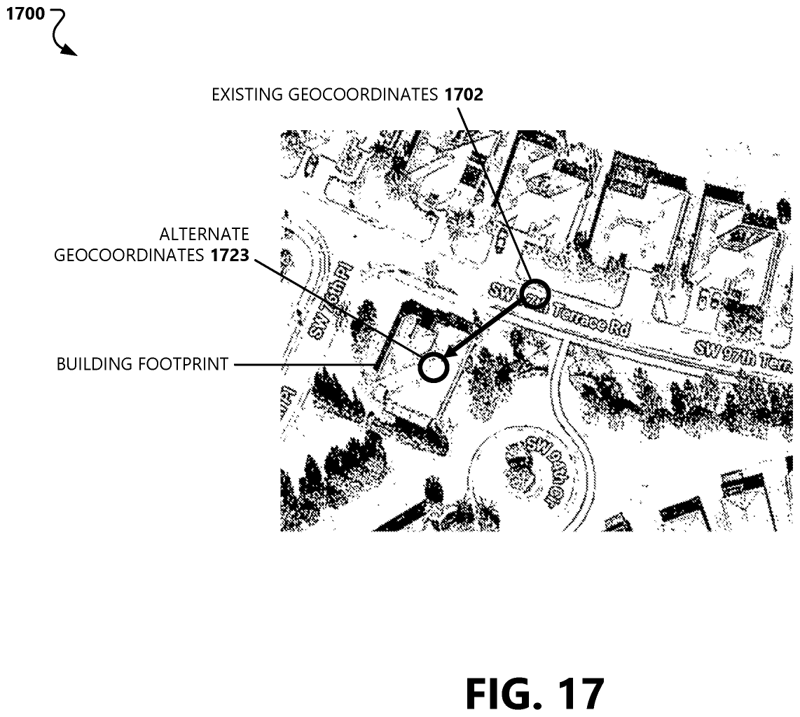

FIG. 17 is an illustration depicting alternate location data that is determined for a site 124 and that is determined to replace the existing location data for the site 124. For example, based on an evaluation of the existing location data for the site 124, the network site validation and remediation system 350 may determine a measure of a medium level of confidence that the existing location data is accurate. According to an example implementation, the medium accuracy score may be below an accuracy threshold. Thus, a determination may be made to determine whether alternate location data for the site 124 has a higher accuracy score than the existing location data. In the example depicted, alternate geocoordinates 1723 determined for the site 124 are determined to be rooftop-level accurate. Thus, for example, the geocode match score for the alternate geocoordinates 1723 may be high, which may cause the updated location data for the site 124 to have a high accuracy score, indicating a high level of confidence that the existing location data is accurate. In some examples, the network site validation and remediation system 350 may determine to automatically replace the existing geocoordinates 1702 with the high-accuracy alternate geocoordinates 1723.

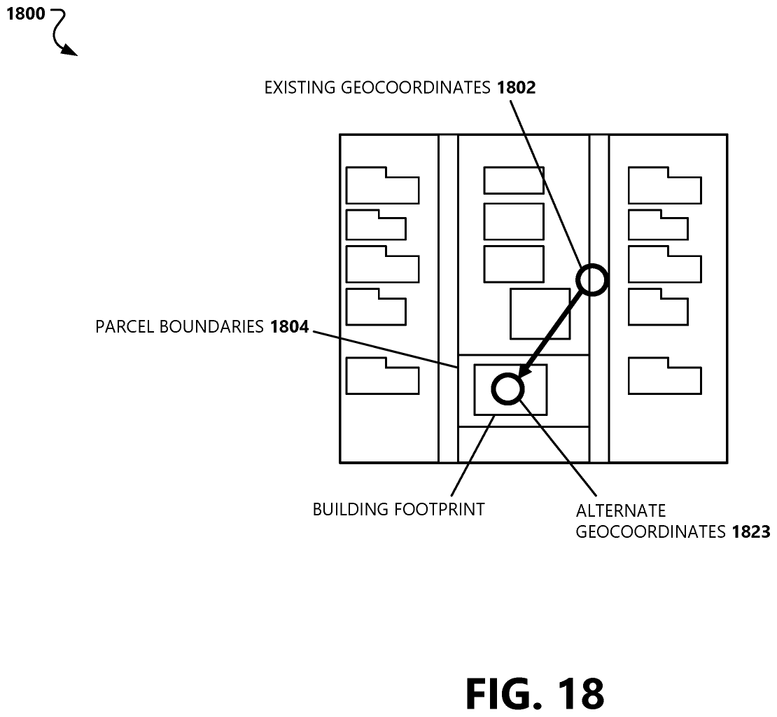

FIG. 18 is another illustration depicting alternate location data that is determined for a site 124 and that is determined to replace the existing location data for the site 124. For example, based on an evaluation of the existing location data for the site 124, the network site validation and remediation system 350 may determine a measure of a low level of confidence that the existing location data is accurate. For instance, and as depicted, the existing geocoordinates 1802 may not be located within parcel boundaries 1804. According to an example implementation, the low accuracy score may be below an accuracy threshold. Thus, a determination may be made to determine whether alternate location data for the site 124 has a higher accuracy score than the existing location data. In the example depicted, alternate geocoordinates 1823 determined for the site 124 are determined to be rooftop-level accurate. Thus, for example, the geocode match score for the alternate geocoordinates 1823 may be high, which may cause the updated location data for the site 124 to have a high accuracy score, indicating a high level of confidence that the alternate coordinate data is accurate. In some examples, the network site validation and remediation system 350 may determine to automatically replace the existing geocoordinates 1802 with the high-accuracy alternate geocoordinates 1823.

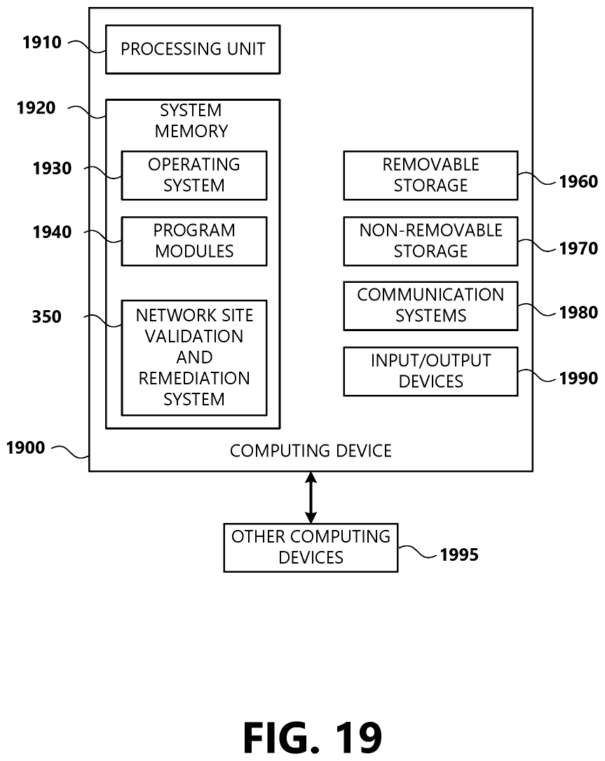

FIG. 19 is a system diagram of a computing device 1900 according to an example. The computing device 1900, or various components and systems of the computing device 1900, may be integrated or associated with the network site validation and remediation system 350. As shown in FIG. 19, the physical components (e.g., hardware) of the computing device 1900 are illustrated and these physical components may be used to practice the various aspects of the present disclosure.

The computing device 1900 may include at least one processing unit 1910 and a system memory 1920. The system memory 1920 may include, but is not limited to, volatile storage (e.g., random access memory), non-volatile storage (e.g., read-only memory), flash memory, or any combination of such memories. The system memory 1920 may also include an operating system 1930 that controls the operation of the computing device 1900 and one or more program modules 1940. The program modules 1940 may be responsible for performing one more of the operations of the methods described above for providing robust network connectivity. A number of different program modules and data files may be stored in the system memory 1920. While executing on the processing unit 1910, the program modules 1940 may perform the various processes described above. One example program module 1940 includes the network site validation and remediation system 350.

The computing device 1900 may also have additional features or functionality. For example, the computing device 1900 may include additional data storage devices (e.g., removable and/or non-removable storage devices) such as, for example, magnetic disks, optical disks, or tape. These additional storage devices are labeled as a removable storage 1960 and a non-removable storage 1970.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 19 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 1900 on the single integrated circuit (chip). The disclosure may also be practiced using other technologies capable of performing logical operations such as, for example, AND, OR, and NOT, including but not limited to mechanical, optical, fluidic, and quantum technologies.

The computing device 1900 may include one or more communication systems 1980 that enable the computing device 1900 to communicate with other computing devices 1995 such as, for example, routing engines, gateways, signings systems and the like. Examples of communication systems 1980 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 1900 may also have one or more input devices and/or one or more output devices shown as input/output devices 1990. These input/output devices 1990 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 1920, the removable storage 1960, and the non-removable storage 1970 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1900. Any such computer storage media may be part of the computing device 1900. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method, comprising:
retrieving, from one or more network site storage systems, existing location data of a plurality of sites, wherein each site comprises a potential service location for telecommunications services and the existing location data for each of the plurality of sites comprises at least existing geocoordinates and an existing address;
determining external location data for the plurality of sites based on the existing location data, wherein determining external location data for the plurality of sites comprises, for each site, at least two of:
determining occupancy data for the site;
determining geocode data for the site;
determining reverse-geolocation data for the site;
determining one or more possible alternate addresses for the site;
determining parcel data for the site;
determining building data for the site; and
determining business location data for the site;
determining accuracy scores for the existing location data, each accuracy score indicating a level of confidence that the existing location data for a site is accurate, wherein determining the accuracy score for each site comprises at least two of:
determining a parcel match score for the parcel data, where the parcel match score is a measure of a match between the existing address and a parcel address;
determining a building match score for the building data, where the building match score is a measure of a match between the existing geocoordinates and building boundaries;
determining a geocode match score for the geocode data, where the geocode match score is a measure of a match between the existing geocoordinates and geocode coordinates;
determining a reverse-geocode match score for the reverse geocode data, where the reverse geocode match score is a measure of a match between the existing address and a reverse-geocode address;
determining an occupancy match score for the occupancy data, where the occupancy match score is a measure of a match between a site unit count of a location aggregation including the site and an occupiable unit count; and
determining a business match score for the business data, where the business match score is a measure of a number of businesses within a threshold distance of the site;
based on determining an accuracy score indicating a set of the existing location data is accurate, validating the existing location data; and
based on determining an accuracy score indicating a set of the existing location data is not accurate, automatically causing at least one mitigation action to be performed.

2. The method of claim 1, wherein causing the at least one mitigation action to be performed comprises:
automatically determining alternate location data for the site, wherein the alternate location data comprises alternate geocoordinates or an alternate address; and
replacing the existing location data with the alternate location data.

3. The method of claim 2, wherein:
determining alternate location data for the site comprises determining the alternate geocoordinates have an accuracy level above an accuracy threshold; and
replacing the existing geocoordinates with the alternate geocoordinates.

4. The method of claim 3, wherein replacing the existing geocoordinates with the alternate geocoordinates comprises replacing the existing geocoordinates with rooftop-level accurate geocode coordinates.

5. The method of claim 3, wherein:
determining the geocode match score comprises determining a plurality of geocode match scores for a plurality of geocode coordinates obtained from different external geocode data sources, the plurality of geocode coordinates including the alternate geocoordinates; and
replacing the existing geocoordinates with the alternate geocoordinates comprises:
determining one or more groups of geocode coordinates within a threshold distance that include existing geocoordinates or geocode coordinates above an accuracy threshold;
selecting, from a largest of the one or more groups, a set of geocode coordinates provided by a highest ranked geocode source from a predefined preference list of geocode sources; and
automatically replacing the existing geocoordinates with the selected set of geocode coordinates.

6. The method of claim 2, further comprising:
determining external location data for the site based on the alternate location data, wherein determining external location data for the site comprises at least two of:
determining secondary occupancy data for the site;
determining secondary geocode data for the site;
determining secondary reverse-geolocation data for the site;
determining one or more possible secondary alternate addresses for the site;
determining secondary parcel data for the site;
determining secondary building data for the site; and
determining secondary business location data for the site; and
determining an accuracy score for the alternate location data, the accuracy score indicating a level of confidence that the alternate location data for the site is accurate, wherein determining the accuracy score for the site comprises at least two of:
determining a parcel match score for the secondary parcel data, where the parcel match score is a measure of a match between the alternate address and a secondary parcel address;
determining a building match score for the secondary building data, where the building match score is a measure of a match between the alternate geocoordinates and secondary building boundaries;
determining a geocode match score for the secondary geocode data, where the geocode match score is a measure of a match between the alternate geocoordinates and secondary geocode coordinates;
determining a reverse-geocode match score for the secondary reverse geocode data, where the reverse geocode match score is a measure of a match between the alternate address and a secondary reverse geocode address;
determining an occupancy match score for the secondary occupancy data, where the occupancy match score is a measure of a match between a site unit count of a location aggregation including the site and a secondary occupiable unit count; and
determining a business match score for the secondary business data, where the business match score is a measure of a number of businesses within a threshold distance of the site; and
based on determining an accuracy score indicating a set of secondary-alternate location data is outside a threshold distance of the alternate location data, validating the alternate location data.

7. The method of claim 6, further comprising, based on determining an accuracy score indicating a set of secondary-alternate location data is within the threshold distance of the alternate location data:
determining external location data for the site based on the secondary-alternate location data;
determining an accuracy score for the secondary-alternate location data, the accuracy score indicating a level of confidence that the secondary-alternate location data for the site is accurate; and
based on determining an accuracy score indicating a set of tertiary-alternate location data is outside a threshold distance of the secondary-alternate location data, validating the secondary-alternate location data.

8. The method of claim 1, wherein, prior to determining external location data for the plurality of sites:
aggregating at least two of the plurality of sites into a location aggregation when the existing addresses of at least two sites include a matching street number and a matching state; and
determining the site unit count for the location aggregation, where the site unit count is a number of the at least two sites included in the location aggregation.

9. The method of claim 1, wherein determining the parcel match score comprises:
determining a string match score between the existing address and the parcel address; and
determining whether the existing geocoordinates for the location are within the parcel boundaries by a threshold distance.

10. The method of claim 1, wherein determining the building match score comprises determining whether the existing geocoordinates for the location are within the building boundaries by a threshold distance.

11. The method of claim 1, wherein determining the geocode match score comprises determining a geo-distance between the existing geocoordinates and the geocode coordinates.

12. The method of claim 1, wherein determining the reverse-geocode match score comprises determining a string match score between the existing address and the reverse-geocode address.

13. A system, comprising:
at least one processor; and
memory storing instructions that, when executed by the at least one processor, cause the system to:
retrieve, from one or more network site storage systems, existing location data of a plurality of sites, wherein each site comprises a potential service location for telecommunications services and the existing location data for each of the plurality of sites comprises at least existing geocoordinates and an existing address;
determine external location data for the plurality of sites based on the existing location data, wherein determining external location data for the plurality of sites comprises, for each site, at least two of:
determine occupancy data for the site;
determine geocode data for the site;
determine reverse-geolocation data for the site;
determine one or more possible alternate addresses for the site;
determine parcel data for the site;
determine building data for the site; and
determine business location data for the site;
determine accuracy scores for the existing location data, each accuracy score indicating a level of confidence that the existing location data for a site is accurate, wherein determining the accuracy score for each site comprises at least two of:
determine a parcel match score for the parcel data, where the parcel match score is a measure of a match between the existing address and a parcel address;
determine a building match score for the building data, where the building match score is a measure of a match between the existing geocoordinates and building boundaries;
determine a geocode match score for the geocode data, where the geocode match score is a measure of a match between the existing geocoordinates and geocode coordinates;
determine a reverse-geocode match score for the reverse geocode data, where the reverse geocode match score is a measure of a match between the existing address and a reverse-geocode address;
determine an occupancy match score for the occupancy data, where the occupancy match score is a measure of a match between a site unit count of a location aggregation including the site and an occupiable unit count; and
determine a business match score for the business data, where the business match score is a measure of a number of businesses within a threshold distance of the site;
based on determining an accuracy score indicating a set of the existing location data is accurate, validate the existing location data; and
based on determining an accuracy score indicating a set of the existing location data is not accurate, automatically cause at least one mitigation action to be performed.

14. The system of claim 13, wherein the at least one mitigation action comprises:
automatically determine alternate location data for the site, wherein the alternate location data comprises at least alternate geocoordinates;
determine the alternate geocoordinates have an accuracy level above an accuracy threshold; and
replace the existing location data with alternate location data including the alternate geocoordinates.

15. The system of claim 14, wherein:
in determining the geocode match score, the instructions cause the system to determine a plurality of geocode match scores for a plurality of geocode coordinates obtained from different external geocode data sources, the plurality of geocode coordinates including the alternate geocoordinates; and
in replacing the existing geocoordinates with the alternate geocoordinates, the instructions cause the system to:
determine one or more groups of coordinates within a threshold distance that include geocode coordinates above an accuracy threshold;
select, from a largest of the one or more groups, a set of geocode coordinates provided by a highest ranked geocode source from a predefined preference list of geocode sources; and
automatically replace the existing geocoordinates with the selected set of geocode coordinates.

16. The system of claim 14, wherein the instructions further cause the system to:
determine external location data for the site based on the alternate location data, wherein determining external location data for the site comprises at least two of:
determine secondary occupancy data for the site;
determine secondary geocode data for the site;
determine secondary reverse-geolocation data for the site;
determine one or more possible secondary alternate addresses for the site;
determining secondary parcel data for the site;
determine secondary building data for the site; and
determine secondary business location data for the site; and
determine an accuracy score for the alternate location data, the accuracy score indicating a level of confidence that the alternate location data for the site is accurate, wherein the accuracy score for the site is based on at least two of:
parcel match score for the secondary parcel data, where the parcel match score is a measure of a match between an alternate address and a secondary parcel address;
a building match score for the secondary building data, where the building match score is a measure of a match between the alternate geocoordinates and secondary building boundaries;
a geocode match score for the secondary geocode data, where the geocode match score is a measure of a match between the alternate geocoordinates and secondary geocode coordinates;
a reverse-geocode match score for the secondary reverse geocode data, where the reverse geocode match score is a measure of a match between the alternate address and a secondary reverse geocode address;
an occupancy match score for the secondary occupancy data, where the occupancy match score is a measure of a match between a site unit count of a location aggregation including the site and a secondary occupiable unit count; and
business match score for the secondary business data, where the business match score is a measure of a number of businesses within a threshold distance of the site; and
based on a determination of an accuracy score indicating a set of secondary-alternate location data is outside a threshold distance of the alternate location data, validate the alternate location data.

17. The system of claim 16, wherein, based on a determination of an accuracy score indicating a set of secondary-alternate location data is within the threshold distance of the alternate location data, the instructions further cause the system to:
determine external location data for the site based on the secondary-alternate location data;
determine an accuracy score for the secondary-alternate location data, the accuracy score indicating a level of confidence that the secondary-alternate location data for the site is accurate; and
based on a determination an accuracy score indicating a set of tertiary-alternate location data is outside a threshold distance of the secondary-alternate location data, validate the secondary-alternate location data.

18. The system of claim 13, wherein, prior to determining external location data for the plurality of sites, the instruction cause the system to:
aggregate at least two of the plurality of sites into a location aggregation when the existing addresses of at least two sites include a matching street number and a matching state; and
determine the site unit count for the location aggregation, where the site unit count is a number of the at least two sites included in the location aggregation.

19. A computer-readable storage medium storing instructions that, when executed by a computer, cause the computer to:
retrieve, from one or more network site storage systems, existing location data of a plurality of sites, wherein each site comprises a potential service location for telecommunications services and the existing location data for each of the plurality of sites comprises at least existing geocoordinates and an existing address;
determine external location data for the plurality of sites based on the existing location data, wherein determining external location data for the plurality of sites comprises, for each site, at least two of:
determine occupancy data for the site;
determine geocode data for the site;
determine reverse-geolocation data for the site;
determine one or more possible alternate addresses for the site;
determine parcel data for the site;
determining building data for the site; and
determine business location data for the site;
determine accuracy scores for the existing location data, each accuracy score indicating a level of confidence that the existing location data for a site is accurate, wherein determining the accuracy score for each site comprises at least two of:
determine a parcel match score for the parcel data, where the parcel match score is a measure of a match between the existing address and a parcel address;
determine a building match score for the building data, where the building match score is a measure of a match between the existing geocoordinates and building boundaries;
determine a geocode match score for the geocode data, where the geocode match score is a measure of a match between the existing geocoordinates and geocode coordinates;
determine a reverse-geocode match score for the reverse geocode data, where the reverse geocode match score is a measure of a match between the existing address and a reverse-geocode address;
determine an occupancy match score for the occupancy data, where the occupancy match score is a measure of a match between a site unit count of a location aggregation including the site and an occupiable unit count; and
determine a business match score for the business data, where the business match score is a measure of a number of businesses within a threshold distance of the site;
based on determining an accuracy score indicating a set of the existing location data is accurate, validate the existing location data; and
based on determining an accuracy score indicating a set of the existing location data is not accurate, automatically cause at least one mitigation action to be performed.

20. The computer-readable storage medium of claim 19, wherein the at least one mitigation action comprises:
automatically determine alternate location data for the site, wherein the alternate location data comprises at least alternate geocoordinates;
determine the alternate geocoordinates have an accuracy level above an accuracy threshold; and
replace the existing location data with alternate location data including the alternate geocoordinates.
